(19) United States
(12) Patent Application Publication
(10) Pub. No.: US 2011/0267603 A1
(43) Pub. Date: Nov. 3, 2011

(54) Fluid Monitoring Apparatus and Methods

(76) Inventor: Andrew Mark Shaw, Exeter (GB)

(21) Appl. No.: 10/593,104

(22) PCT Filed: Mar. 15, 2005
(86) PCT No.: PCT/GB2005/050035

§ 371 Date: May 6, 2008

(51) Int. Cl. G01N 21/17; G01N 21/41

(52) U.S. Cl. 356/128; 356/436

(57) ABSTRACT

The invention is generally concerned with apparatus and methods for monitoring fluids, in particular critical fluids such as lubricants, in particular oil, based upon evanescent wave techniques. We describe an oil sensor module for use with attenuated total internal (ATIR) reflection apparatus for optically determining the condition of the oil. The sensor module comprises an evanescent wave sensor, preferable in the form of a tapered optical fibre with a high reflectivity mirror at one or both ends; a module housing for said sensor; and an optical connector for connecting said sensor to the ATIR apparatus. Preferably the sensor module is in the form of a dipstick.

This invention is generally concerned with apparatus and methods for monitoring fluids, in particular critical fluids such as lubricants, based upon evanescent wave techniques. These will be described with particular reference to cavity ring-down spectroscopy although embodiments of the apparatus and methods do not rely upon multiple passes of a light pulse back and forth within a cavity.

Cavity Ring-Down Spectroscopy is known as a high sensitivity technique for analysis of molecules in the gas phase (see, for example, G. Berden, R. Peeters and G. Meijer, Int. Rev. Phys. Chem., 19, (2000) 565, P. Zalicki and R. N. Zare, J. Chem. Phys. 102 (1995) 2708, M. D. Levinson, B. A. Paldus, T. G. Spence, C. C. Harb, J. S. Harris and R. N. Zare, Chem. Phys. Lett. 290 (1998) 335, B. A. Paldus, C. C. Harb, T. G. Spence, B. Wilkie, J. Xie, J. S. Harris and R. N. Zare, J. App. Phys. 83 (1998) 3991. D. Romanini, A. A. Kachanov and F. Stoeckel, Chem. Phys. Lett. 270 (1997) 538). The CRDS technique can readily detect a change in molecular absorption coefficient of 10⁻⁶ cm⁻¹, with the additional advantage of not requiring calibration of the sensor at the point of measurement since the technique is able to determine an absolute molecular concentration based upon known molecular absorbance at the wavelength or wavelengths of interest. Although the acronym CRDS makes reference to spectroscopy in many cases measurements are made at a single wavelength rather than over a range of wavelengths.

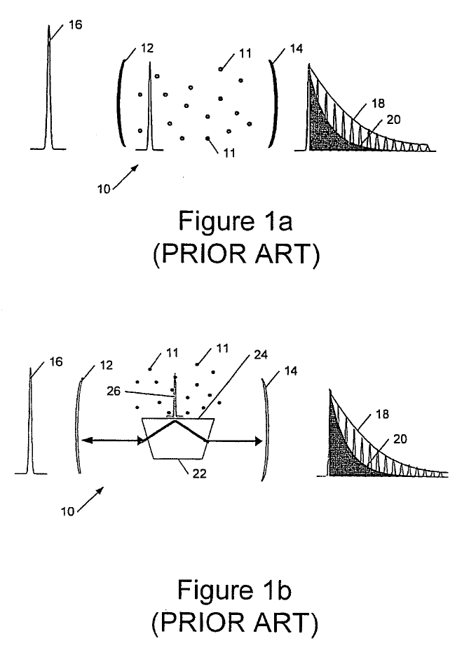

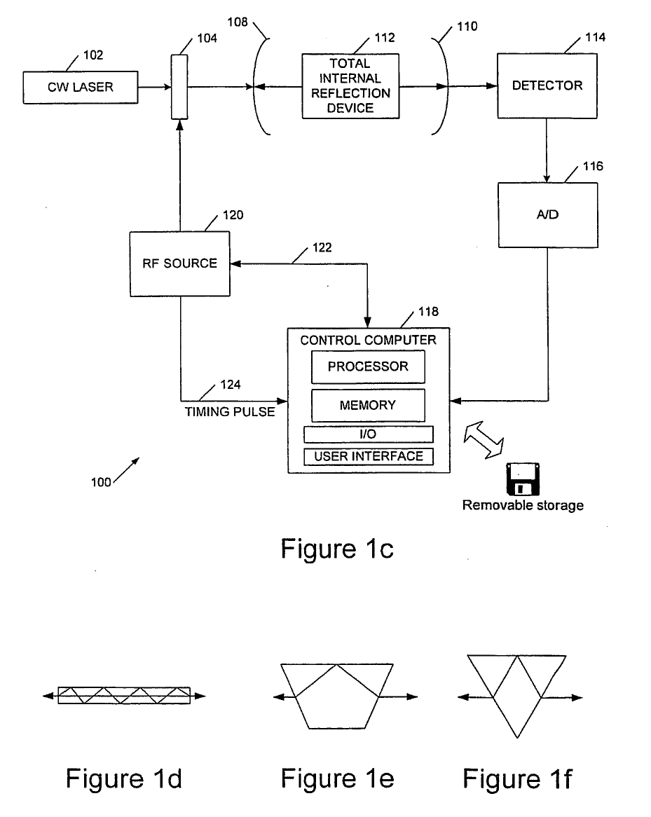

FIG. 1a, which shows a cavity 10 of a CRDS device, illustrates the main principles of the technique. The cavity 10 is formed by a pair of high reflectivity mirrors at 12, 14 positioned opposite one another (or in some other configuration) to form an optical cavity or resonator. A pulse of laser light 16 enters the cavity through the back of one mirror (mirror 12 in FIG. 1a) and makes many bounces between the mirrors, losing some intensity at each reflection. Light leaks out through the mirrors at each bounce and the intensity of light in the cavity decays exponentially to zero with a half-life decay time, τ. The light leaking from one or other mirror, in FIG. 1a preferably mirror 14, is detected by a photo multiplier tube (PMT) as a decay profile such as decay profile 18 (although the individual bounces are not normally resolved). Curve 18 of FIG. 1a illustrates the origin of the phrase “ring-down”, the light ringing backwards and forwards between the two mirrors and gradually decreasing in amplitude. The decay time τ is a measure of all the losses in the cavity, and when molecules 11 which absorb the laser radiation are present in the cavity the losses are greater and the decay time is shorter, as illustratively shown by trace 20.

Since the pulse of laser radiation makes many passes through the cavity even a low concentration of absorbing molecules (or atoms, ions or other species) can have a significant effect on the decay time. The change in decay time, Δ τ, is a function of the strength of absorption of the molecule at the frequency, v, of interest α (v) (the molecular extinction coefficient) and of the concentration per unit length, lₛ, of the absorbing species and is given by equation 1 below.

Δτ=tᵣ/{2(1−R)+α(v)l} (Equation 1)

where R is the reflectivity of each of mirrors 12, 14 and tᵣ is the round trip time of the cavity, tᵣ=c/2L where c is the speed of light and L is the length of the cavity. Since the molecular absorption coefficient is a property of the target molecule, once Δτ has been measured the concentration of molecules within the cavity can be determined without the need for calibration.

It will be appreciated that to employ equation 1 measurements of the mirror reflectivities, the molecular absorption (or extinction) coefficient, the cavity length and (where different) the sample lengths are necessary but these may be determined in advance of any particular measurement, for example, during initial set up of a CRDS machine. Likewise since the decay times are generally relatively short, of the order of tens of nanoseconds, a timing calibration may also be needed, although again this may be performed when the apparatus is initially set up.

It will be further appreciated that to achieve a high sensitivity the reflectivities of mirrors 12, 14 should be high (whilst still permitting a detectable level of light to leak out) and typically R equals 0.9999 to provide of the order of 10⁴ bounces. If the total losses in the cavity are around 1% there will only be 3 or 4 bounces and consequently the sensitivity of the apparatus is very much reduced; in practical terms it is desirable to have total losses less than 0.25%, corresponding to around 200 bounces during decay time τ, or approximately 1000 bounces during ring down of the entire cavity.

One problem with CRDS is that the technique is only suitable for sensing molecules that are introduced into the cavity in a gas since if a liquid or solid is introduced into the cavity losses become very large and the technique fails. To address this problem so-called evanescent wave CRDS (e-CRDS) can be employed, as described in the Applicant's co-pending UK patent application no. 0302174.8 filed 30 Jan. 2003. Background prior art relating to e-CRDS can be found in U.S. Pat. No. 5,943,136, U.S. Pat. No. 5,835,231 and U.S. Pat. No. 5,986,768, EP1195582A, A. J. Hallock et al. “Use of Broadband, Continuous-Wave diode Lasers in Cavity Ring-Down Spectroscopy for Liquid Samples”, Applied Spectroscopy, 57(5), 2003, 571-573, and D. Romanini et al, “CW cavity ring down spectroscopy”, Chem. Phys. Lett. 264 (1997) 316-322.

FIG. 1b, in which like elements to those of FIG. 1a are indicated by like reference numerals, shows the idea underlying evanescent wave CRDS. In FIG. 1b a prism 22 (as shown, a pellin broca prism) is introduced into the cavity such that total internal reflection (TIR) occurs at surface 24 of the prism (in some arrangements a monolithic cavity resonator may be employed). Total internal reflection will be familiar to the skilled person, and occurs when the angle of incidence (to a normal surface) is greater than a critical angle θ_{c} where sin θ_{c} is equal to n₂/n₁ where n₂ is the refracted index of the medium outside the prism and n₁ is the refractive index of the material of which the prism is composed. Beyond this critical angle light is reflected from the interface with substantially 100% efficiency back into the medium of the prism, but a non-propagating wave, called an evanescent wave (e-wave) is formed beyond the interface at which the TIR occurs. This e-wave penetrates into the medium above the prism but it's intensity decreases exponentially with distance from the surface, typically over a distance of the order of the a wavelength. The depth at which the intensity of the e-wave falls to 1/e (where e=2.718) of it's initial value is known at the penetration depth of the e-wave. For example, for a silica/air interface under 630 nm illumination the penetration depth is approximately 175 nm and for a silica/water interface the depth is approximately 250 nm, which may be compared with the size of a molecule, typically in the range 0.1-1.0 nm.

A molecule adjacent surface 24 and within the e-wave field can absorb energy from the e-wave illustrated by peak 26, thus, in effect, absorbing energy from the cavity. In such circumstances the “total internal reflection” is sometimes referred to as attenuated total internal reflection (ATIR). As with the conventional CRDS apparatus a loss in the cavity is detected as a change in cavity ring-down decay time, and in this way the technique can be extended to measurements on molecules in a liquid or solid phase as well as molecules in a gaseous phase. In the configuration of FIG. 1b molecules near the total internal reflection surface 24 are effectively in optical contact with the cavity, and are sampled by the e-wave resulting from the total internal reflection at the surface.

### SUMMARY OF THE INVENTION

The inventors have recognised that techniques related to e-CRDS can be employed to determine the condition of a fluid, in particular a fluid having a high optical density, for which conventional optical techniques fail. For example, conventional optical techniques are difficult to apply to fluids having an absorbance of greater than unity as so little light is transmitted by such fluids.

Thus the invention provides a sensor module for use with attenuated total internal reflection or other evanescent field sensing apparatus for optically determining the condition of a fluid, the module having an evanescent wave sensor, a module housing for the sensor, and an optical connector to connect the sensor to the apparatus.

Preferably the sensor comprises a portion of fibre optic configured, preferably tapered. To “expose” the evanescent wave field in the core. Preferably the connector comprises another portion of the same fibre optic, in embodiments to avoid the need to splice two fibres together. Preferably a high reflectivity mirror is formed, preferably directly, on either or both ends of the fibre to provide a two-pass system or, with two mirrors, an optical cavity. The housing may be fabricated from a ceramic material for physical/chemical robustness; this may comprise a ferule at either end of the sensor portion of the fibre, optionally spaced apart for example by one or more posts, in order to provide a fluid-permeable region in the vicinity of the “exposed” portion of the fibre.

In embodiments the sensor module is incorporated into a dipstick, for example with a metal housing and a cage around the evanescent wave sensing portion of the fibre. The invention also provides ATIR or other evanescent field sensing apparatus incorporating the module/dipstick.

Thus according to another aspect of the present invention there is apparatus, in particular provided attenuated total internal reflection (TIR) apparatus, for optically determining the condition of a fluid, the apparatus comprising: a light source to provide light for interacting with said fluid; a detector for detecting a level of light from said light source; and an optical path between said light source and said detector, said optical path including a reflection from an evanescent wave interface, such as a substantially totally internally reflecting (TIR) interface; and wherein said apparatus is configured such that said fluid may be brought sufficiently close to said interface for an evanescent wave formed by total internal reflection of light at said interface to interact with said fluid; whereby a condition of said fluid is determinable from said detected light level.

Preferably the optical path further includes a mirror (or other reflecting surface) reflection so that the light makes a double pass through a sample region comprising said TIR interface. This facilitates fabrication of a deployable device, which can thus be single-ended, and increases sensitivity. Optionally a pair of mirrors (or other reflecting surfaces) can be employed to form an optical cavity for ring-down monitoring of a fluid characteristic or condition but it has been found experimentally that in many cases such multiple reflections of light back and forth through the sample region (reflecting from the interface) are not necessary to obtain a useful sensitivity.

In preferred embodiments the optical path includes a fibre optic (FO). This facilitates practical applications of the technology, in particular outside a lab environment, and the fabrication of inexpensive or even disposable sensing devices. The TIR interface may be formed by modifying the fibre, for example by removing a portion of the FO surface and/or tapering the FO, to provide access to the evanescent wave. By controlling the degree of modification/taper the evanescent field, in particular the extension of the evanescent field from the interface, may also be controlled and hence adapted to a particular sensing function or application. For example a FO may be selected or fabricated such that an evanescent field extension from the interface (or taper diameter/length) is suitable for the absorbance or expected absorbance range of a fluid whose condition is to be determined or monitored.

In some preferred embodiments the FO is provided with a protective housing, which in embodiments may be configured as a dipstick.

The monitored fluid may comprise a lubricant, such as engine oil, for any of a range of engines, turbines, generators, transmissions and the like, or a hydraulic fluid. In other applications the monitored fluid may comprise oil, for example crude or pre-refined oil or oil at any stage in the refinement process including, but not limited to, feed stock and vistar/post-cracking oil.

The interaction of the evanescent wave with the fluid will generally include some absorption of light by the fluid but other interactions may also be present. For example, depending upon the refractive index of the fluid (which may change with temperature and/or other parameters such as age, use/treatment history and the like) there may be some coupling or propagation of light from the TIR interface into the fluid. More generally the apparatus can be though of a monitoring the complex refractive index of a fluid, that is either or both of a real component of the refractive index and an imaginary component representing absorption. In this context the skilled person will understand that although there will be a high degree of TIR at the interface when no fluid is present, when fluid is introduced to the apparatus the TIR will be attenuated and may even disappear, for example when the refractive index of the fluid is such that light is effectively coupled out of the apparatus into the fluid.

In preferred embodiments the apparatus includes a signal processor coupled to the detector. This may comprise a conventional computing device with a digitiser to digitise an output from the detector. The signal processor may then be programmed to detect a change in the fluid condition, for example in substantially real-time, and to provide an output signal. Such an output signal may comprise data or a data file, for example sent to a disk or over a network, and/or a signal to drive an indicator such as a warning indicator.

The apparatus may be configured to detect/determine a degree of scatter of light by the fluid, for example by illuminating and detecting the attenuated TIR at two or more wavelengths or colours (either discrete or continuous). This can be used as a measure of degradation of the fluid, being responsive to a level or concentration of particulates within the fluid.

Measuring at three (or two to four or more) colours facilitates distinguishing between a change in response due to scattering, which is wavelength dependent (as 1/λ⁴), for example due to a change in particulate density or characteristics, and a change in response due to a change in temperature of the monitored fluid, which affects all the colours in a similar manner, for example the response at all three colours changing similarly.

In a related method there is provided a method of optically determining the condition of a fluid using attenuated total internal reflection, the method comprising: measuring an attenuation of a total internal reflection at an interface due to an interaction of light with said fluid mediated by an evanescent wave formed at said interface; and determining a condition of said fluid from said attenuation.

The invention also provides a method, and corresponding apparatus, for determining a degree of degradation of a fluid, the method comprising measuring a level of particulate scattering by said fluid; and determining said degree of degradation of the fluid from said level of particulate scattering. Again measuring a response at two or more different colours can help distinguish between particulate scattering and temperature effects.

The skilled person will appreciate that embodiments of the above described methods may be implemented using computer program code to process a signal from an optical, in particular (A)TIR, sensor. Examples of this are described in more detail later. Such computer program (or processor control) code may be provided on a carrier such as a CD- or DVD-ROM or on read only memory (Firmware) or as a signal on an optical or electrical signal carrier. Such computer program code may be written in any conventional programming language and may be distributed between a plurality of coupled components, for example over a network.

The invention also provides an optical cavity, in particular a fibre optic, including a TIR surface or interface as described above. The optical cavity may be provided without one or both mirrors since these may be provided by the cavity sensing apparatus within which the TIR surface or interface is to operate.

In the various above described aspects of the invention the apparatus/methods need not operate in the TIR regime, depending upon the taper parameters and/or the fluid the condition of which is to be determined. For example, with a fibre optic evanescent wave sensor for some fluid refractive indices light may be coupled out of the providing a coupled propagation regime rather than a guided mode of operation. Nonetheless such an operating regime is still useful. In general the optical properties of a fluid depend on complex refractive index (CRI) which in turn may be monitored by the absorption and/or scatter losses from the propagation of the radiation coupled to the evanescent field. Broadly two regimes of “propagation” occur: 1) the TIR condition is maintained within the fibre-liquid/fluid and substantially only the radiation in the e-field interacts with the fluid, typically by both mechanisms of scatter and absorption. When the CRI of the fluid is above that of the effective refractive index (RI) of the taper the radiation may be at least partially coupled out of the fibre through the evanescent field, with losses characteristic of the CRI of the fluid and the taper. Thin tapers of order 15μ minimum diameter favour the guided regime and fatter tapers favour the coupled regime. Thus, for example, the above described aspect of the invention suitable for use with ATIP apparatus is also suitable for operation in a non-ATIR regime, and generally here (A)TIR should be understood as also including sensors/apparatus in which radiation is partially or wholly coupled out of an evanescent wave interface.

Thus according to a further aspect of the invention there is provided optical fluid sensing apparatus, the apparatus comprising, an illumination source to source illumination at an operating wavelength of the apparatus, and a tapered fibre optic configured to couple light at said operating wavelength out of said taper and into said fluid, whereby a real of complex refractive index of said fluid may be determined.

### Further Features and Advantages of Preferred Arrangements

Further features and advantages of some implementations of systems related to those described above will now be described. These have previously been set out in detail in the Applicant's co-pending International patent application number PCT/GB2004/000020, filed on 8 Jan. 2004, the entire contents of which are hereby incorporated by reference.

The sensitivity of an e-CRDS or a conventional CRDS-based device may be improved by taking a succession of measurements and averaging the results. However the frequency at which such a succession of measurements can be made is limited by the maximum pulse rate of the pulsed laser employed for injecting light into the cavity. This limitation can be addressed by employing a continuous wave (CW) laser such as a laser diode, since such lasers can be switched on and off faster than a pulsed laser's maximum pulse repetition rate. However, there are significant difficulties associated with coupling light from a CW laser into the cavity, particularly where a so-called stable cavity is employed, typically comprising planar or concave mirrors.

We have previously described, in UK patent application no. 0302174.8, how these difficulties may be addressed by employing a cavity ring-down sensor with a light source, such as a continuous wave laser, of a power and bandwidth sufficient to overcome losses within the cavity and couple energy into at least two modes of oscillation (either transverse or longitudinal) of the cavity. Preferably the light source is operable as a substantially continuous source and has a bandwidth sufficient to provide at least a half maximum power output across a range of frequencies equal to at least a free spectral range of the cavity. This facilitates coupling of light into the cavity even when modes of the light source and cavity are not exactly aligned. The light source may be shuttered or electronically controlled so that the excitation may be cut off to allow measurement of a ring-down decay curve. To facilitate accurate measurement of a ring-down time the CW light source output is preferably cut off in less than 100 ns, more preferably less than 50 ns. When driven with a CW laser the cavity preferably has a length of greater than 0.5m more preferably greater than 1.0m because a longer cavity results in closer spaced longitudinal modes.

An evanescent wave cavity-based optical sensor may comprise: an optical cavity formed by a pair of highly reflective surfaces such that light within the cavity makes a plurality of passes between the surfaces, an optical path between the surfaces including a reflection from a totally internally reflecting (TIR) surface, the reflection from the TIR surface generating an evanescent wave to provide a sensing function; a light source to inject light into the cavity; and a detector to detect a light level within the cavity. Thus absorption of said evanescent wave is detectable using the detector to provide the sensing function.

In another arrangement a cavity ring-down sensor may comprise: a ring-down optical cavity for sensing a substance modifying a ring-down characteristic of the cavity; a light source for exciting the cavity; and a detector for monitoring the ring-down characteristic. The cavity may comprise a fibre optic sensor including a fibre optic cable configured to provide access to an evanescent field of light guided within the cable for the sensing.

In general the evanescent wave may either sense a substance directly or may mediate a sensing interaction through sensing a substance or a property of a material. The detector detects a change in light level in the cavity resulting from absorption of the evanescent wave, and whilst in practice this is almost always performed by measuring a ring-down characteristic of the cavity, in principle a ring-up characteristic of a cavity could additionally or alternatively be monitored. As the skilled person will appreciate the reflecting surfaces of the cavity are optical surfaces generally characterized by a change in reflective index, and may physically comprise internal or external surfaces.

The number of passes light makes through the cavity depends upon the Q of the cavity which, for most (but not all) applications, should be as high as possible. Although the cavity ring-down is responsive to absorption in the cavity this absorption may either be direct absorption by a sensed material or may be a consequence of some other physical effect, for example surface plasmon resonance (SPR) or measured property.

We have also previously described, in UK patent application no. 0302174.8, how inn a preferred embodiment the cavity comprises a fibre optic cable with reflective ends. In embodiments this provides a number of advantages including physical and optical robustness, physically small size, durability, ease of manufacture, and flexibility, enabling use of such a sensor in a wide range of non lab-based applications.

To provide an evanescent-wave sensor a fibre optic cable may be modified to provide access to an evanescent field of light guided within the cable. The invention provides a fibre-optic sensor of this sort, for example for use in evanescent wave cavity ring-down device of the general type described above.

A fibre optic cable typically comprises a core configured to guide light down the fibre surrounded by an outer cladding of lower refractive index than the core. A sensing portion of the fibre optic cable may be configured have a reduced thickness cladding over part or all of the circumference of the fibre such that an evanescent wave from said guided light is accessible for sensing. By reducing the thickness of the cladding, in embodiments to expose the core, the evanescent wave can interact directly with a sensed material or substance or attenuation of light within the cavity via absorption of the evanescent wave can be indirectly modified, for example in an SPR-based sensor by modifying the interaction of a surface plasmon excited in overlying conductive material with the evanescent wave (a shift or modification of a plasmon resonance changing the absorption).

One, or preferably both ends of the fibre optic cable may be provided with a highly reflecting surface such as a Bragg stack. The fibre optic cable thus provides a stable cavity, that is guided light confined within the cable will retrace its path many times. Preferably the fibre optic cable (and hence cavity) has a length of at least a length of 0.5m, and more preferably of at least 1.0m, to facilitate coupling of a continuous wave laser to the fibre optic sensor, as described above. The sensor may be coupled to a fibre optic extension and, optionally, may include an optical fibre amplifier; such an amplifier may be incorporated within the cavity.

The fibre optic cable is preferably a step index fibre, although a graded index fibre may also be used, and may comprise a single mode or polarization-maintaining or high birefringence fibre. Preferably the sensing portion of the cable has a loss of less than 1%, more preferably less than 0.5%, most preferably less than 0.25%, so that the cavity has a relatively high Q and consequently a high sensitivity. Where the sensor is to be used in a liquid the core of the fibre should have a greater refractive index than that of the liquid in which it is to be immersed in order to restrict losses from the cavity. The sensor may be attached to a Y-coupling device to facilitate single-ended use, for example inside a human or animal body.

The skilled person will understand that features and aspects of the above described sensors and apparatus may be combined.

In all the above aspects of the invention references to optical components and to light includes components for and light of non-visible wavelengths such as infrared and other light.

These and other aspects of the present invention will now be further described, by way of example only, with reference to the accompanying figures:

FIGS. 1a-1f show, respectively, an operating principle of a CRDS-type system, an operating principle of an e-CRDS-type system, a block diagram of a continuous wave e-CRDS system, and first, second and third total internal reflection devices for a CW e-CRDS system;

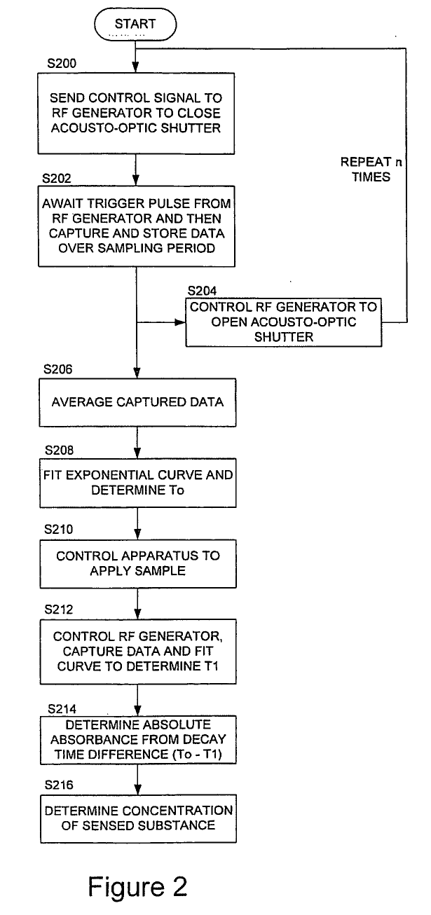

FIG. 2 shows a flow diagram illustrating operation of the system of FIG. 1c;

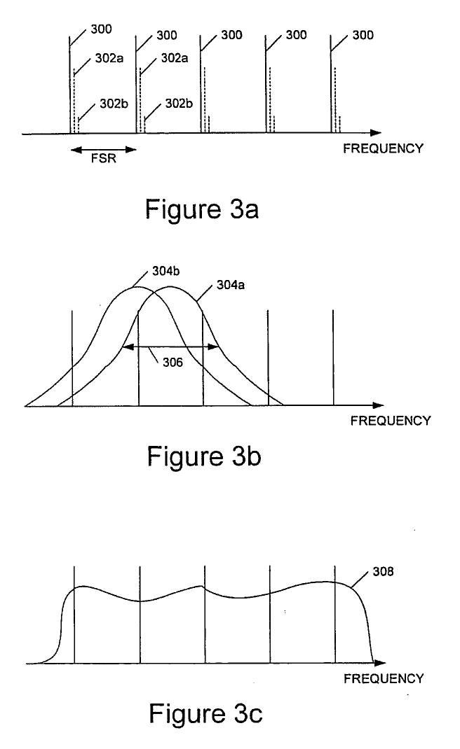

FIGS. 3a-3c show, respectively, cavity oscillation modes for the system of FIG. 1c, a first spectrum of a CW laser for use with the system of FIG. 1c, and a second CW laser spectrum for use with the system of FIG. 1c;

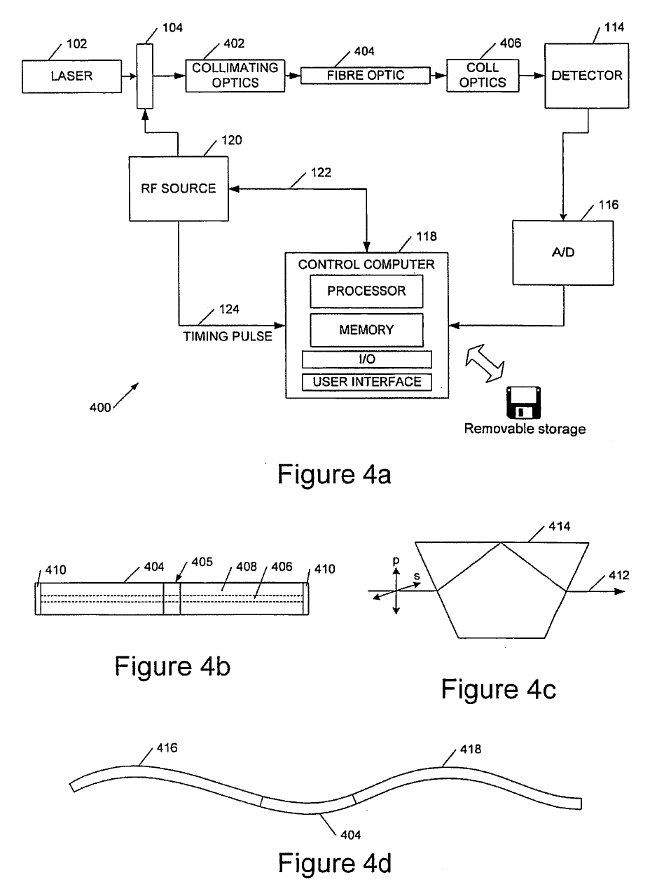

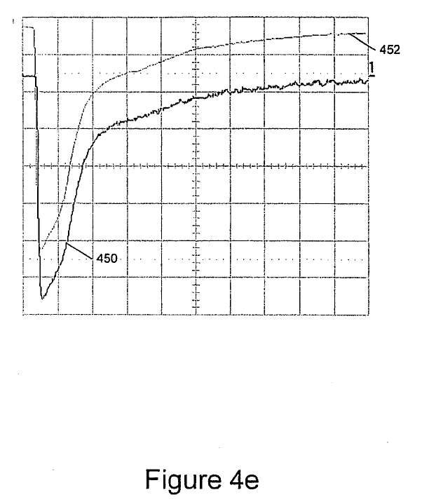

FIGS. 4a-4e show, respectively, a fibre optic-based e-CRDS system, a fibre optic cable for the system of FIG. 4a, an illustration of the effect of polarization in a total internal reflection device, a fibre optic cavity-based sensor, and fibre optic cavity ring-down profiles;

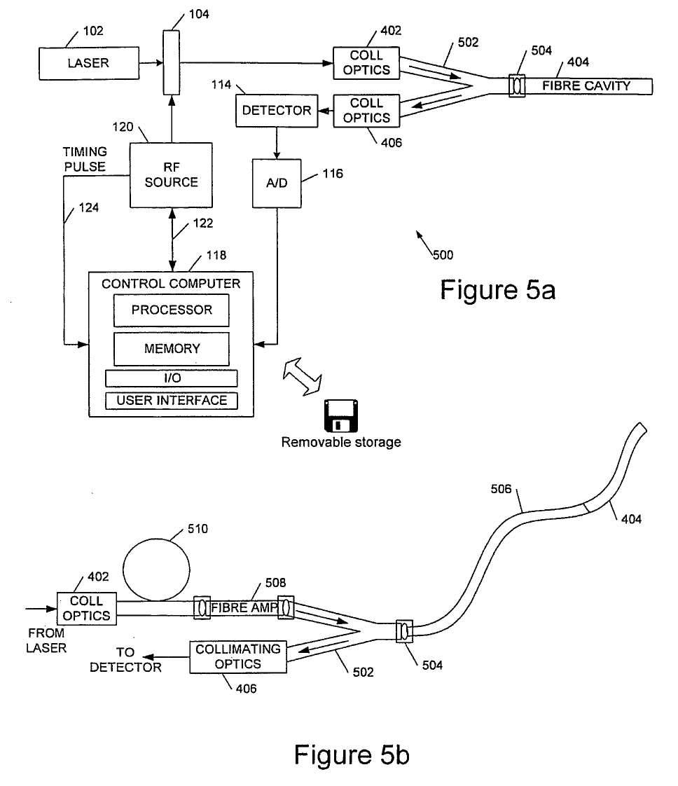

FIGS. 5a and 5b show, respectively, a second fibre optic based e-CRDS device, and a variant of this device;

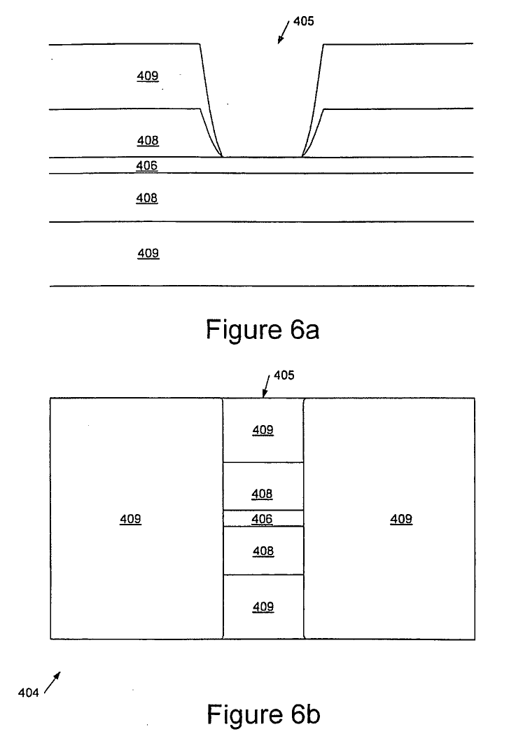

FIGS. 6a and 6b show, respectively, a cross sectional view and a view from above of a sensor portion of a fibre optic cavity;

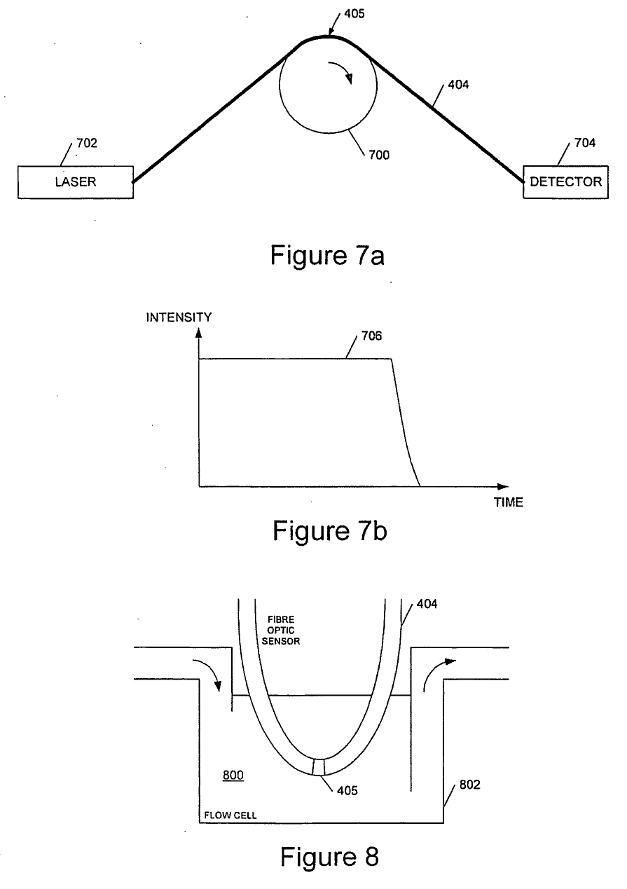

FIGS. 7a and 7b show, respectively, a procedure for forming the sensor portion of FIG. 6, and a detected light intensity-time graph associated with the procedure of FIG. 7a;

FIG. 8 shows an example of an application of an e-CRDS-based fibre optic sensor;

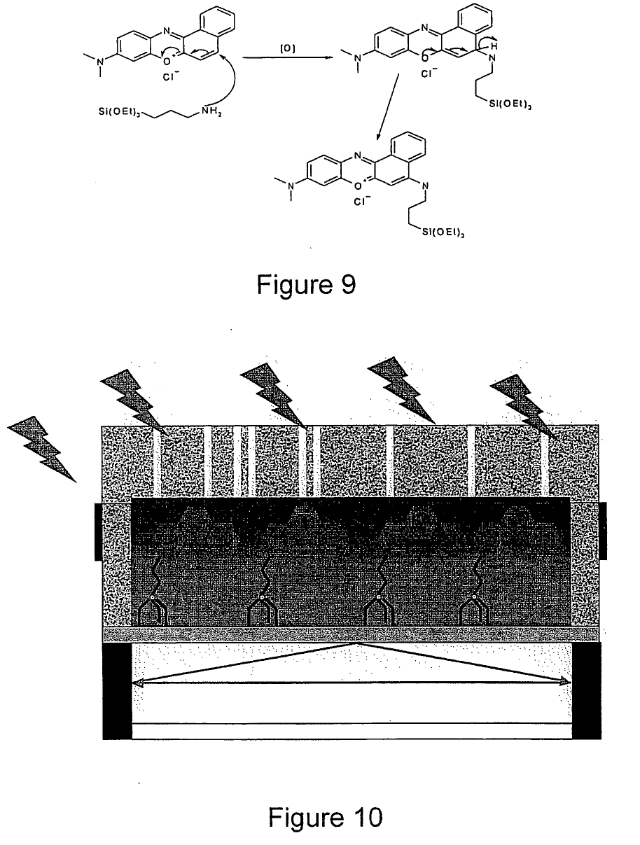

FIG. 9 shows synthesis of a Nile Blue derivative;

FIG. 10 shows a schematic diagram of a chrompohore attached to a sensor surface to provide a pH sensor;

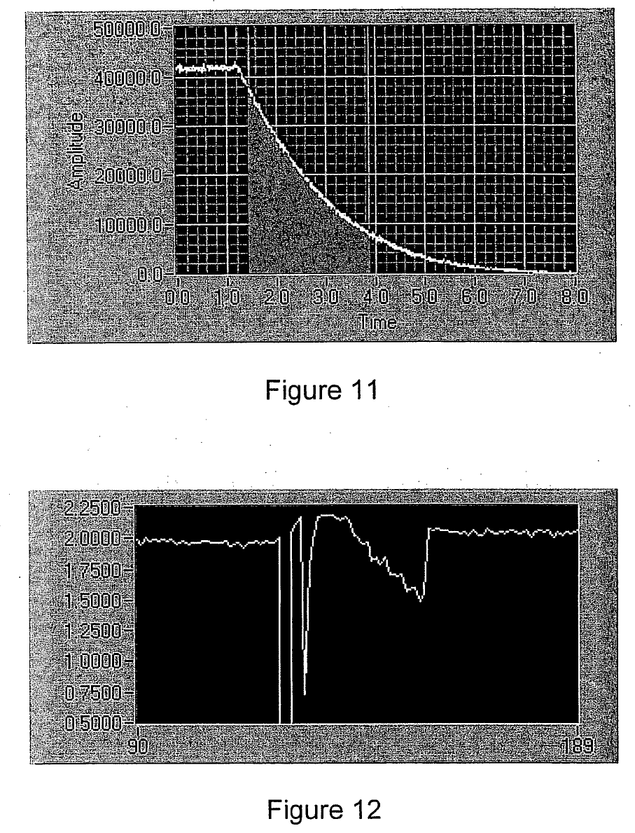

FIG. 11 shows an example of a ring-down trace for a fibre optic cavity;

FIG. 12 shows fibre optic bend losses in a 2m fibre cavity;

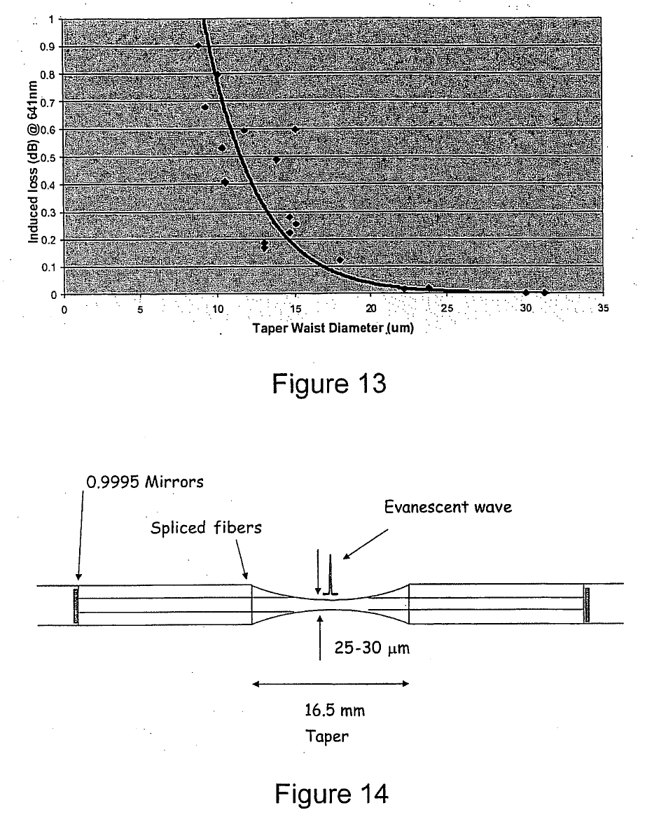

FIG. 13 shows a graph of cavity loss against taper waist for a tapered fibre optic cavity with crystal violet deposited on a totally internally reflecting evanescent wave surface of the fibre taper;

FIG. 14 shows a fibre optic cavity incorporating a taper;

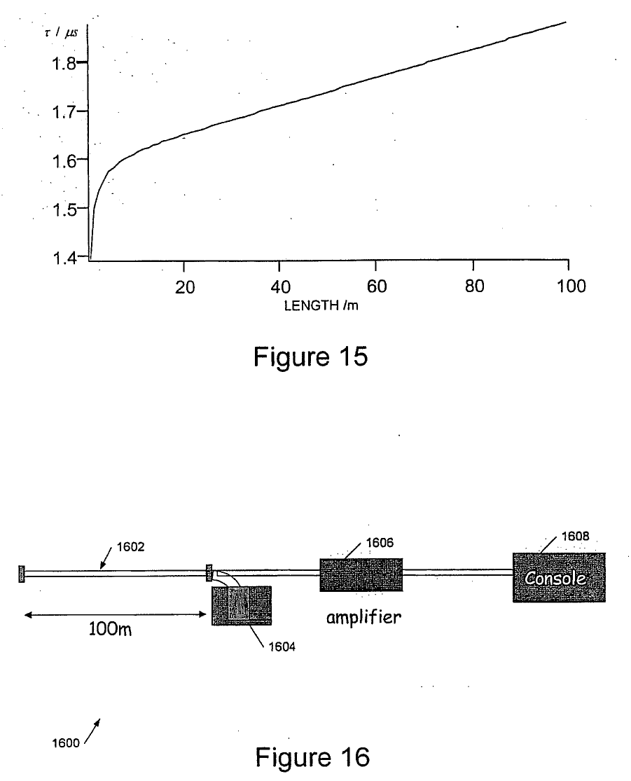

FIG. 15 shows variation of cavity ring-down time τ with cavity length for a fibre cavity;

FIG. 16 shows a wavelength division multiplexed fibre optic cavity sensor system;

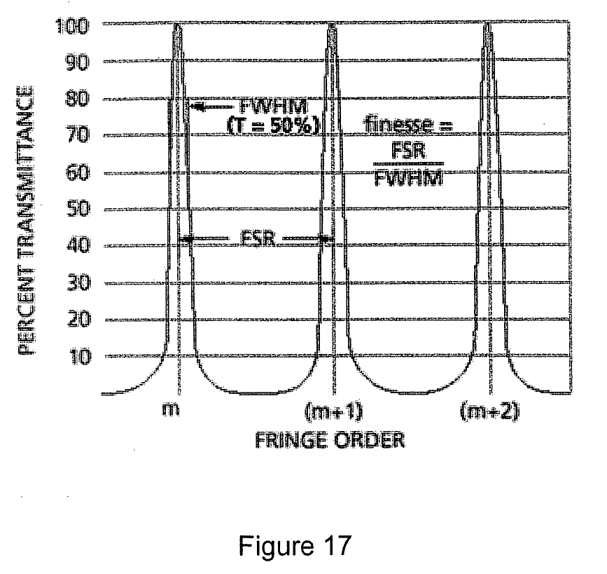

FIG. 17 shows transmittance of an optical cavity illustrating the cavity free spectral range and finesse;

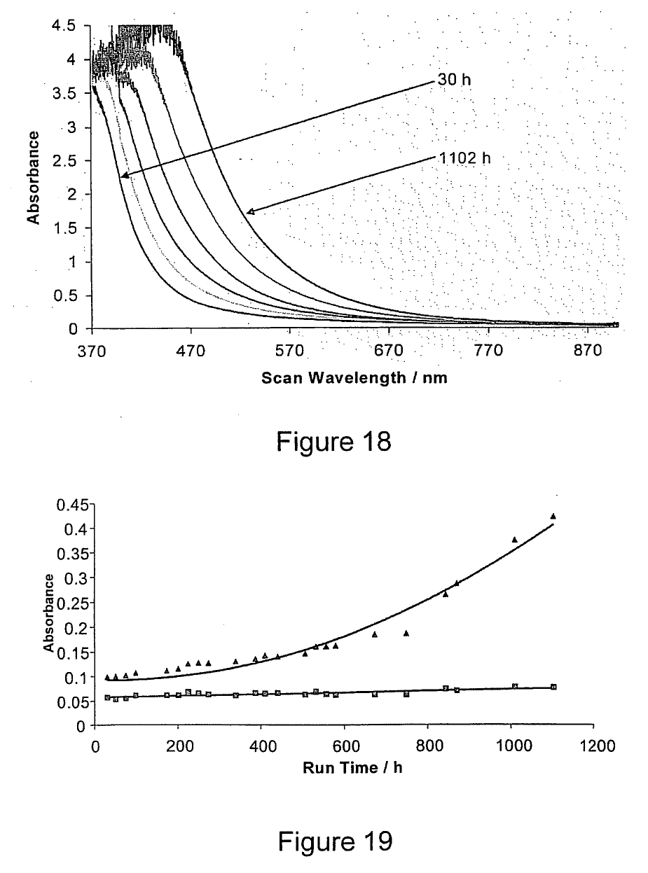

FIG. 18 shows UV/Visible spectra for Eurolite 10W-30 during temperature degradation;

FIG. 19 shows variation of absorbance at 637 nm and 820 nm with thermal degradation;

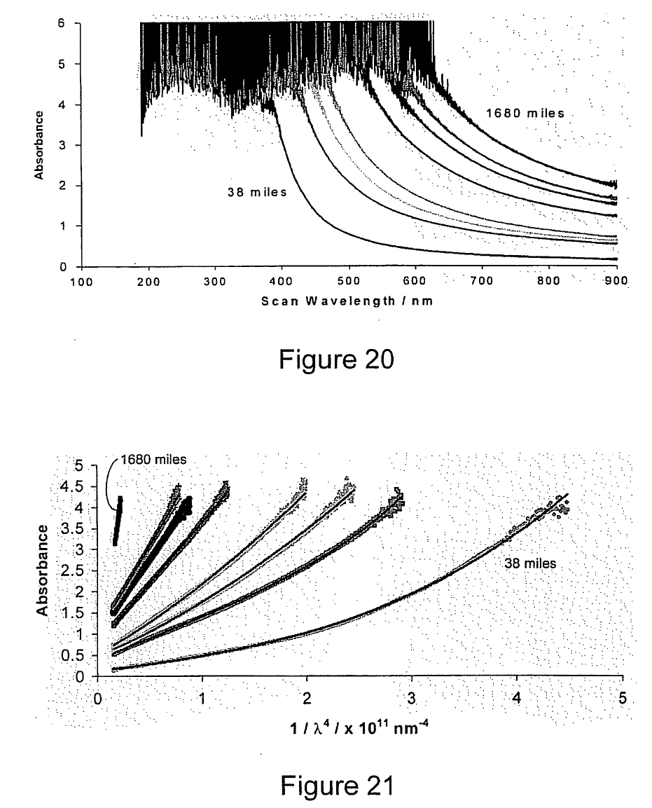

FIG. 20 shows UV/visible spectra for vehicle oil degradation using Eurolite oil (flushed & changed) at 38 miles, 178 miles, 358 miles, 505 miles, 758 miles, 1011 miles, 1320 miles, and 1680 miles;

FIG. 21 shows absorbance vs 1/λ⁴ showing the evolution of scatter-dominated spectra at 38 miles, 178 miles, 308 miles, 505 miles, 758 miles, 1011 miles, 1320 miles and 1680 miles;

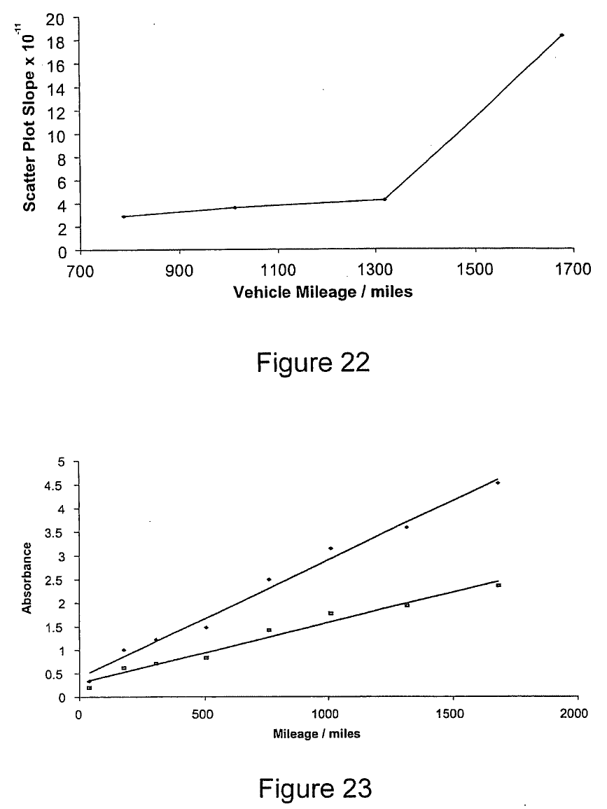

FIG. 22 shows a plot of straight-line gradient in FIG. 21 vs vehicle mileage, showing oil performance degradation;

FIG. 23 shows variation of absorbance at 637 nm and 820 nm in vehicle test oil;

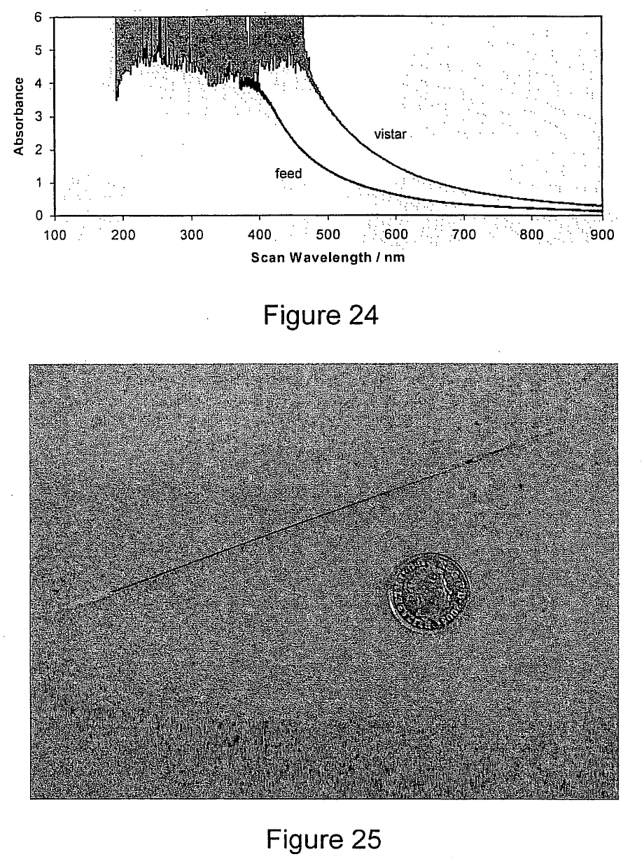

FIG. 24 UV/Visible spectra for crude oil and vistar;

FIG. 25 shows a fibre optic dipstick (with a 10 pence piece for scale);

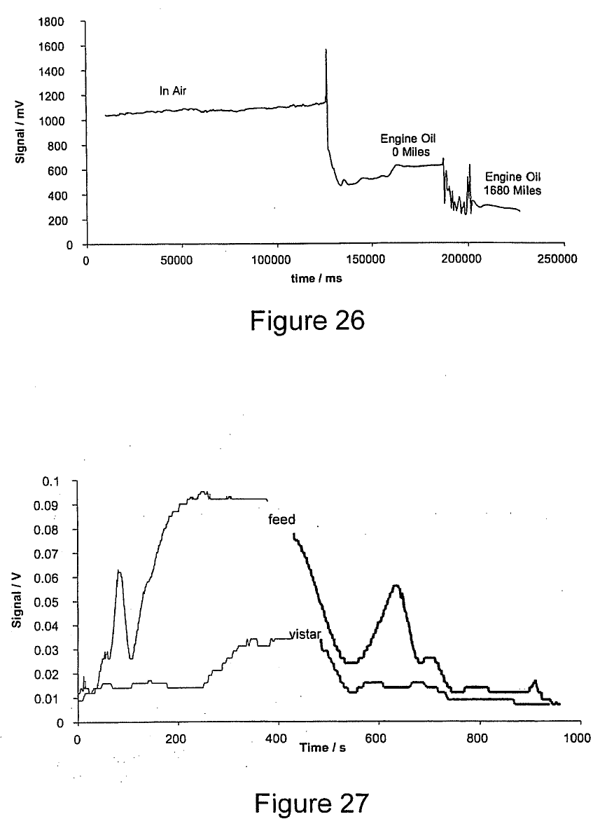

FIG. 26 shows variation of a dipstick response for engine oil (Eurolite 10W-30) for clean oil and after 1680 miles;

FIG. 27 shows dipstick responses in crude oil samples of feed and vistar for heating (to the left) and cooling (to the right);

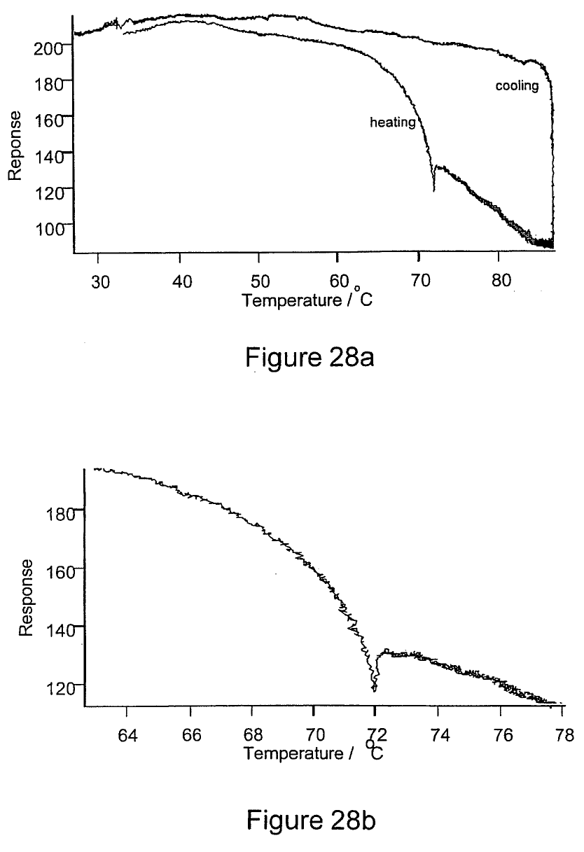

FIG. 28a shows the response (arbitrary units) of a fibre optic dipstick according to an embodiment of the present invention monitoring heating and cooling of Castrol R40 racing oil, and FIG. 28b shows detail of the transition of FIG. 28a;

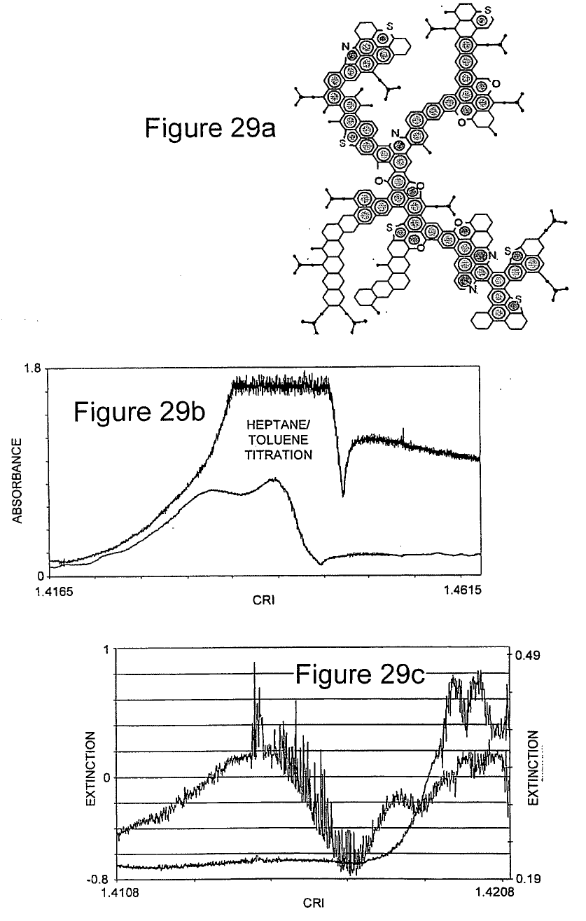

FIGS. 29a to 29c show a typical asphaltene particle and graphs of absorbance and extinction against complex refractive index;

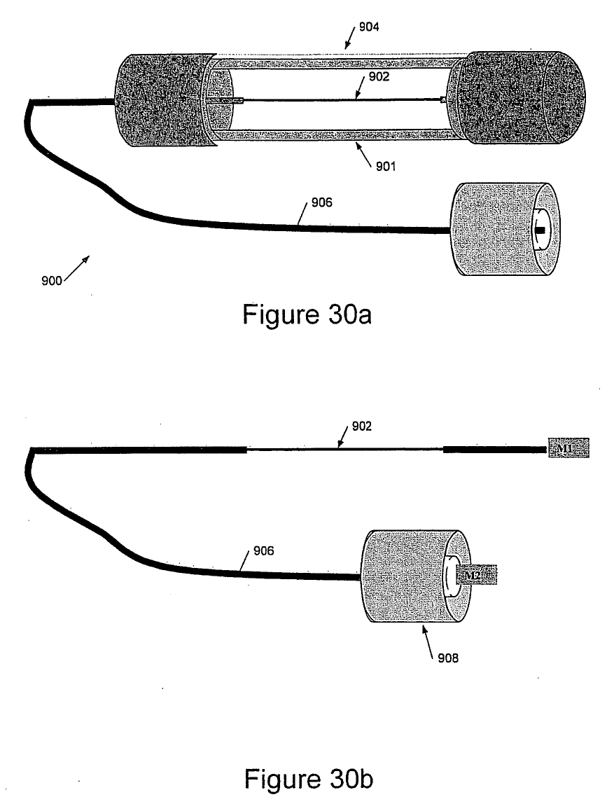

FIGS. 30a and 30b show, respectively, a further example of a fibre optic dipstick, and a fibre optic cavity for the dipstick of FIG. 30a; and

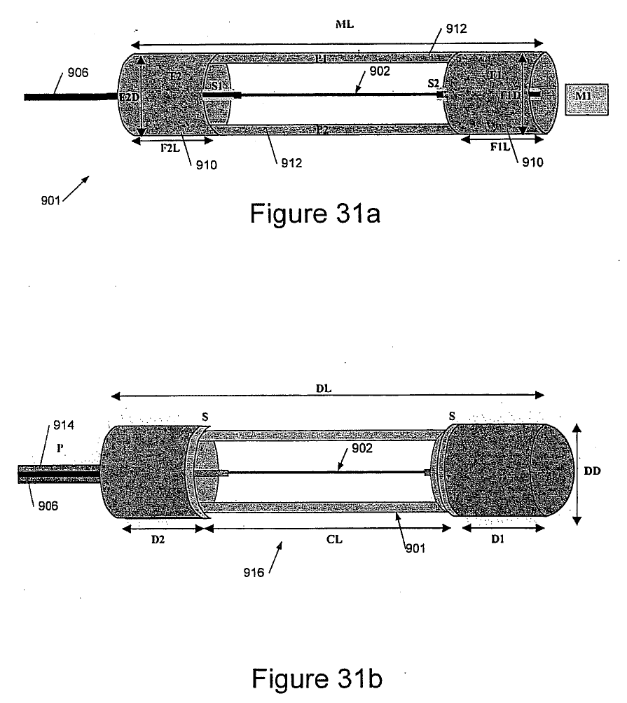

FIGS. 31a and 31b show, respectively, a fibre optic sensor module, and a dipstick incorporating the module.

### Cavity Ring-Down Sensing Apparatus

We will first describe details of some particular preferred examples of e-CRDS-based sensing apparatus and will then, with particular reference to FIG. 9 onwards, describe techniques and improvements embodying aspects of the present invention.

Referring now to FIG. 1c, this shows an example of an e-CRDS-based system 100, in which light is injected into the cavity using a continuous wave (CW) laser 102. In the apparatus 100 of FIG. 1c the ring-down cavity comprises high reflectivity mirrors 108, 110 and includes a total internal reflection device 112. Mirrors 108 and 110 may be purchased from Layertec, Ernst-Abbe-Weg 1, D-99441, Mellingen, Germany. In practice the tunability of the system may be determined by the wavelength range over which the mirrors provide an adequately high reflectivity. Light is provided to the cavity by laser 102 through the rear of mirror 108 via an acousto-optic (AO) modulator 104 to control the injection of light. In one embodiment the output of laser 102 is coupled into an optical fibre and then focused onto a AO modulator 104 with 100 micron spot, the output from AOM 104 then can be collected by a further fibre optic before being introduced into the cavity resonator. This arrangement facilitates chop times of the order of 50 ns, such fast chop times being desirable because of the relatively low finesse of the cavity resonator.

Laser 102 may comprise, for example, a CW ring dye laser operating at a wavelength of approximately 630 nm or some other CW light source, such as a light emitting diode may be employed. For reasons which will be explained further below, the bandwidth of laser (or other light source) 102 should be greater than one free spectral range of the cavity formed by mirrors 108,110 and in one dye laser-based embodiment laser 102 has a bandwidth of approximately 5 GHz. A suitable dye laser is the Coherent 899-01 ring-dye laser, available from Coherent Inc, California, USA. Use of a laser with a large bandwidth excites a plurality of modes of oscillation of the ring-down cavity and thus enables the cavity be “free running”, that is the laser cavity and the ring-down cavity need not rely on positional feedback to control cavity length to lock modes of the two cavities together. The sensitivity of the apparatus scales with the square root of the chopping rate and employing a continuous wave laser with a bandwidth sufficient to overlap multiple cavity modes facilitates a rapid chop rate, potentially at greater than 100 KHz or even greater than 1 MHz.

A radio frequency source 120 drives AO modulator 104 to allow the CW optical drive to cavity 108, 110 to be abruptly switched off (in effect the AO modulator acts as a controllable diffraction grating to steer the beam from laser 102 into or away from cavity 108, 100). A typical cavity ring-down time is of the order of a few hundred nanoseconds and therefore, in order to detect light from a significant number of bounces in the cavity, the CW laser light should be switched off in less than 100 ns, and preferably in less than about 30 ns. Data collected during this initial 100 ns period, that is data from an initial portion of the ring-down before the laser has completely stopped injecting light into the cavity, is generally discarded. To achieve such a fast switch-off time with the above mentioned dye laser an AO modulator such as the LM250 from Isle Optics, UK, may be used in conjunction with a RF generator such as the MD250 from the same company.

The RF source 120 and, indirectly, the AO modulator 104, is controlled by a control computer 118 via an IEEE bus 122. The RF source 120 also provides a timing pulse output 124 to the control computer to indicate when light from laser 102 is cut off from the cavity 108-110. It will be recognized that the timing edge of the timing pulse should have a rise or fall time comparable with or preferably faster than optical injection shut-off time.

Use of a tunable light source such as a dye laser has advantages for some applications but in other applications a less tunable CW light source, such as a solid state diode laser may be employed, again in embodiments operating at approximately 630 nm. It has been found that a diode laser may be switched off in around 10 ns by controlling the electrical supply to the laser, thus providing a simpler and cheaper alternative to a dye laser for many applications. In such an embodiment RF source 120 is replaced by a diode laser driver which drives laser 102 directly, and AO modulator 104 may be dispensed with. An example of a suitable diode laser is the PPMT LD1338-F2, from Laser 2000 Ltd, UK, which includes a suitable driver, and a chop rate for the apparatus, and in particular for this laser, may be provided by a Techstar FG202 (2 MHz) frequency generator.

A small amount of light from the ring-down cavity escapes through the rear of mirror 110 and is monitored by a detector 114, in a preferred embodiment comprises a photo-multiplier tube (PMT) in combination with a suitable driver, optionally followed by a fast amplifier. Suitable devices are the H7732 photosensor module from Hammatsu with a standard power supply of 15V and an (optional) Ortec 9326 fast pre-amplifier. Detector 114 preferably has a rise time response of less than 100 ns more preferably less than 50 ns, most preferably less than 10 ns. Detector 114 drives a fast analogue-to-digital converter 116 which digitizes the output signal from detector 114 and provides a digital output to the control computer 118; in one embodiment an A to D on board a LeCroy waverunner LT 262 350 MHz digital oscilloscope was employed. Control computer 118 may comprise a conventional general purpose computer such as a personal computer with an IEEE bus for communication with the scope or A/D 116 may comprise a card within this computer. Computer 118 also includes input/output circuitry for bus 122 and timing line 124 as well as, in a conventional manner, a processor, memory, non-volatile storage, and a screen and keyboard user interface. The non-volatile storage may comprise a hard or floppy disk or CD-ROM, or programmed memory such as ROM, storing program code as described below. The code may comprise configuration code for LabView (Trade Mark), from National Instruments Corp, USA, or code written in a programming language such as C.

Examples of total internal reflection devices which may be employed for device 112 of FIG. 1c are shown in FIGS. 1d, 1e and 1f. FIG. 1d shows a fibre optic cable-based sensing device, as described in more detail later. FIG. 1e shows a first, Pellin Broca type prism, and FIG. 1f shows a second prism geometry. Prisms of a range of geometries, including Dove prisms, may be employed in the apparatus of FIG. 1c, particularly where an anti-reflection coating has been applied to the prism. The prisms of FIGS. 1e and 1f may be formed from a range of materials including, but not limited to glass, quartz, mica, calcium fluoride, fused silica, and borosilicate glass such as BK7.

Referring now to FIG. 2, this shows a flow diagram of one example of computer program code operating on control computer 118 to control the apparatus of FIG. 1c.

At step S200 control computer 118 sends a control signal to RF source 120 over bus 122 to control radio frequency source 120 to close AO shutter 104 to cut off the excitation of cavity 108-110. Then at step S202, the computer waits for a timing pulse on line 124 to accurately define the moment of cut-off, and once the timing pulse is received digitized light level readings from detector 114 are captured and stored in memory. Data may be captured at rates up to, for example, 1 G samples per second (1 sample/ns at either 8 or 16 bit resolution) preferably over a period of at least five decay lifetimes, for example, over a period of approximately 5 μs. Computer 118 then controls RF generator to re-open the shutter and the procedure loops back to step S200 to repeat the measurement, thereby capturing a set of cavity ring-down decay curves in memory.

When a continuous wave laser source is used to excite the cavity decay curves may be captured at a relatively high repetition rate. For example, in one embodiment decay curves were captured at a rate of approximately 20 kHz per curve, and in theory it should be possible to capture curves virtually back-to-back making measurements substantially continuously (with a small allowance for cavity ring-up time). Thus, for example, when capturing data over a period of approximately 5 μs it should be possible to repeat measurements at a rate of approximately 20 kHz. The data from the captured decay curves are then averaged at step S206, although in other embodiments other averaging techniques, such as a running average, may be employed.

At step S208 the procedure fits an exponential curve to the averaged captured data and uses this to determine a decay time τ₀ for the cavity in an initial condition, for example when no material to be sensed is present. The decay time τ₀ is the time taken for the light intensity to fall to 1/e of its initial value (e=2.718). Any conventional curve fitting method may be employed; one straight-forward method is to take a natural logarithm of the light intensity data and then to employ a least squares straight line fit. Preferably data at the start and end of the decay curve is omitted when determining the decay time, to reduce inaccuracies arising from the finite switch-off time of the laser and from measurement noise. Thus for example data between 20 percent and 80 percent of an initial maximum may be employed in the curve fitting. Optionally a baseline correction to the captured light intensity may be applied prior to fitting the curve; this correction may be obtained from an initial calibration measurement.

Following this initial decay time measurement computer 118 controls the apparatus to apply a sample (gas, liquid or solid) to the total internal reflection device 112 within the ring-down cavity; alternatively the sample may be applied manually. The procedure then, at step S212, effectively repeats steps S200-S208 for the cavity including the sample, capturing and averaging data for a plurality of ring-down curves and using this averaged data to determine a sample cavity ring-down decay time τ₁. Then, at step S214, the procedure determines an absolute absorption value for the sample using the difference in decay times (τ₀−τ₁) and, at step S216, the concentration of the sensed substance or species can be determined. This is described further below.

In an evanescent wave ring-down system such as that shown in FIG. 1c the total (absolute) absorbance can be determined from Δτ=τ₁−τ₀ using equation 2 below.

$$Abs = \frac{Δ t}{τ {τ}_{0}} ( \frac{{t}_{r}}{2} ) \qquad ( Equation 2 )$$

In equation 2 tᵣ is the round trip time for the cavity, which can be determined from the speed of light and from the optical path length including the total internal reflection device. The molecular concentration can then be determined using equation 3;

Absorbance=εCL (Equation 3)

where ε is the (molecular) extinction co-efficient for the sensed species, C is the concentration of the species in molecules per unit volume and L is the relevant path length, that is the penetration depth of the evanescent wave into the sensed medium, generally of the order of a wavelength. Since the evanescent wave decays away from the total internal reflection interface strictly speaking equation 3 should employ the Laplace transform of the concentration profile with distance from the TIR surface, although in practice physical interface effects may also come into play. A known molecular extinction co-efficient may be employed or, alternatively, a value for an extinction co-efficient for equation 3 may be determined by characterizing a material beforehand.

Referring next to FIG. 3a this shows a graph of frequencies (or equivalently, wavenumber) on the horizontal axis against transmission into a high Q cavity such as cavity 108, 110 of FIG. 1c, on the vertical axis. It can be seen that, broadly speaking, light can only be coupled into the cavity at discrete, equally-spaced frequencies corresponding to allowed longitudinal standing waves within the cavity known as longitudinal cavity modes. The interval between these modes is known as the free spectral range (FSR) of the cavity and is defined as equation 4 below.

FSR=(l/2c′) (Equation 4)

Where l is the length of the cavity and c′ is the effective speed of light within the cavity, that is the speed of light taking into account the effects of a non-unity refractive index for materials within the cavity. For a one-meter cavity, for example, the free spectral range is approximately 150 MHz. Lines 300 in FIG. 3a illustrate successive longitudinal cavity modes. FIG. 3a also shows (not to scale) a set of additional, transverse cavity modes 302a, b associated with each longitudinal mode, although these decay rapidly away from the longitudinal modes. The transverse modes are much more closely spaced than the longitudinal modes since they are determined by the much shorter transverse cavity dimensions. To couple continuous wave radiation into the cavity described by FIG. 3a the light source with sufficient bandwidth to overlap at least too longitudinal cavity modes may be employed. This is shown in FIG. 3b.

FIG. 3b shows FIG. 3a with an intensity (Watts per m²) or equivalently power spectrum 304a, b for a continuous wave laser superimposed. It can be seen that provided the full width at half maximum 306 of the laser output spans at least one FSR laser radiation should continuously fill the cavity, even if the peak of the laser output moves, as shown by spectra 304a and b. In practice the laser output may not have the regular shape illustrated in FIG. 3b and FIG. 3c illustrates, diagrammatically an example of the spectral output 308 of a dye laser which, broadly speaking, comprises a super imposition of a plurality of broad resonances at the cavity modes of the laser.

Referring again to FIG. 3b it can be seen that as the peak of the laser output moves, although two modes are always excited these are not necessarily the same two modes. It is desirable to continuously excite a cavity mode, taking into account shifts in mode position caused by vibration and/or temperature changes and it is therefore preferable that the laser output overlaps more than two modes, for example, five modes (as shown in FIG. 3c) or ten modes. In this way even if mode or laser frequency changes one mode at least is likely to be continuously excited. To cope with large temperature variations a large bandwidth may be needed and for certain designs of instruments, for example, fibre optic-based instruments it is similarly desirable to use a CW laser with a bandwidth of five, ten or more FSRs. For example a CW ring dye laser with a bandwidth of 5 GHz has advantageously employed with a cavity length of approximately one meter and hence an FSR of approximately 150 MHz.

For clarity transverse modes have not been shown in FIG. 3b or FIG. 3c but it will be appreciated light may be coupled into modes with a transverse component as well as a purely longitudinal modes, although to ensure continuous excitation of a cavity it is desirable to overlap at least two different longitudinal modes of the cavity

In order to excite a cavity mode sufficient power must be coupled into the cavity to overcome losses in the cavity so that the mode, in effect rings up. Preferably, however, at least half the maximum laser intensity at its peak frequency is delivered into at least two modes since this facilitates fast repetition of decay curve measurement and also increases sensitivity since decay curves will begin from a higher initial detected intensity. It will be appreciated that when the bandwidth of the CW laser overlaps with longitudinal modes of the ring-down cavity as described above, the power within the cavity depends on the incident power of the exciting laser, which enables the power within the cavity to be controlled, thus facilitating power dependent measurements and sensing.

FIG. 4a shows a fibre optic-based e-CRDS type sensing system 400 similar to that shown in FIG. 1c, in which like elements are indicated by like reference numerals. In FIG. 4a, however, mirrors 108, 110, and total internal reflection device 112 are replaced by fibre optic cable 404, the ends of which have been treated to render them reflective to form a fibre optic cavity. In addition collimating optics 402 are employed to couple light into fibre optic cable 404 and collimating optics 406 are employed to couple light from fibre optic cable 404 into detector 414.

FIG. 4b shows further details of fibre optic cable 404, which, in a conventional manner comprises a central core 406 surrounded by cladding 408 of lower refractive index than the core. Each end of the fibre optic cable 404 is, in the illustrated embodiment polished flat and provided with a multi layer Bragg stack 410 to render it highly reflective at the wavelength of interest. As the skilled person will be aware, a Bragg stack is a stack of quarter wavelength thick layers of materials of alternating refractive indices. To deposit the Bragg stacks the ends of the fibre optic cable are first prepared by etching away the surface and then polishing the etched surface flat to within, for example, a tenth of a wavelength (this polishing criteria is a commonly adopted standard for high-precision optical surfaces). Bragg stacks may then be deposited by ion sputtering of metal oxides; such a service is offered by a range of companies including the above-mentioned Layertec, Gmbh. Fibre optic cable 404 includes a sensor portion 405, as described further below.

Preferably optical fibre 404 is a single mode step index fibre, advantageously a single mode polarization preserving fibre to facilitate polarization-dependent measurements and to facilitate enhancement of the evanescent wave field. Such enhancement can be understood with reference to FIG. 4c which shows total internal reflection of light 412 at a surface 414. It can be seen from inspection of FIG. 4c that p-polarized light (within the plane containing light 412 and the normal to surface 414) generates an evanescent wave which penetrates further from surface 414 than does s-polarized light (perpendicular to the plane containing light 412 and the normal to surface 414).

The fibre optic cable is preferably selected for operation at a wavelength or wavelengths of laser 102. Thus, for example, where laser 102 operates in the region of 630 nm so called short-wavelength fibre may be employed, such as fibre from INO at 2470 Einstein Street, Sainte-Foy, Quebec, Canada. Broadly speaking suitable fibre optic cables are available over a wide range of wavelengths from less than 500 nm to greater than 1500 nm. Preferably low loss fibre is employed. In one embodiment single mode fibre (F601A from INO) with a core diameter of 5.6 μm (a cut-off at 540 nm, numerical aperture of 0.11, and outside diameter of 125 μm) and a loss of 7 dB/km was employed at 633 nm, giving a decay time of approximately 1.5 is with a one meter cavity and an end reflectivity of R=0.999. In general the decay time is given by equation 5 below where the symbols have their previous meanings, f is the loss in the fibre (units of m⁻¹ i.e. percentage loss per metre) and l is the length of the fibre in metres.

Δτ=tᵣ/{2(1−R)+fl} (Equation 5)

FIG. 4d illustrates a simple example of an alternative configuration of the apparatus of FIG. 4a, in which fibre optic cavity 404 is incorporated between two additional lengths of fibre optic cable 416, 418, light being injected at one end of fibre optic cable 416 and recovered from fibre optic cable 418, which provides an input to detector 114. Fibre optic cables 414, 416 and 418 may be joined in any conventional manner, for example using a standard FC/PC—type connector.

FIG. 4e shows two examples of cavity ring-down decay curves obtained with apparatus similar to that shown in FIG. 4a with a cavity of length approximately one meter and the above mentioned single mode fibre. FIG. 4e shows two sampling oscilloscope traces captured at 500 mega samples per second with a horizontal (time) grid division of 0.2 μs and a vertical grid division of 50 μV. Curve 450 represents a single measurement and curve 452 and average of nine decay curve measurements (in FIG. 4e the curve has been displaced vertically for clarity) the decay time for the averaged decay curve 452 was determined to be approximately 1.7 μs. The slight departure from an exponential shape (a slight kink in the curve) during the initial approximately 100 ns is a consequence of coupling of radiation into the cladding of the fibre, which is rapidly attenuated by the fibre properties and losses to the surroundings.

Referring now to FIG. 5a this shows a variant of the apparatus of FIG. 4a, again in which like elements are indicated by like reference numerals. In FIG. 5a a single-ended connection is made to fibre cavity 404 although, as before, both ends of fibre 404 are provided with highly reflecting surfaces. Thus in FIG. 5a a conventional Y-type fibre optic coupler 502 is attached to one end of fibre cavity 404, in the illustrated example by an FC/PC screw connector 504. The Y connector 502 has one arm connected to collimating optics 402 and its second arm connecting to collimating optics 406. To allow laser light to be launched into fibre cavity 404 and light escaping from fibre cavity 404 to be detected from a single end of the cavity. This facilitates use of a fibre cavity-based sensor (such as is described in more detail below) in many applications, in particular applications where access both ends of the fibre is difficult or undesirable. Such applications include intra-venous sensing within a human or animal body and sensing within an oil well bore hole.

FIG. 5b shows a variant in which fibre cavity 404 is coupled to Y-connector 502 via an intermediate length of fibre optic cable 506 (which again may be coupled to cable 504 via a FC/PC connector). FIG. 5b also illustrates the use of an optional optical fibre amplifier 508 such as an erbium-doped fibre amplifier. In the illustrated example fibre amplifier 508 is acting as a relay amplifier to boost the output of collimating optics 402 after a long run through a fibre optic cable loop 510. (For clarity in FIG. 5b the pump laser for fibre amplifier 508 is not shown). The skilled person will appreciate that many other configurations are possible. For example provided that the fibre amplifier is relatively linear it may be inserted between Y coupler 502 and collimating optics 506 without great distortion of the decay curve. Generally speaking, however, it is preferable that detector 114 is relatively physically close to the output arm of Y coupler 512, that is preferably no more than a few centimeters from the output of this coupler to reduce losses where practically possible; alternatively a fibre amplifier may be incorporated within cavity 404. In further variants of the arrangement of figures multiple fibre optic sensors may be employed, for example by splitting the shuttered output of laser 102 and capturing data from a plurality of detectors, one for each sensor. Alternatively laser 102, shutter 104, and detector 114 may be multiplexed between a plurality of sensors in a rotation.

To utilize the fibre optic cavity 404 as a sensor of an e-CRDS based instrument access to an evanescent wave guided within the fibre is needed. FIGS. 6a and 6b show one way in which such access may be provided. Broadly speaking a portion of cladding is removed from a short length of the fibre to expose the core or more particularly to allow access to the evanescent wave of light guided in the core by, for example, a substance to be sensed.

FIG. 6a shows a longitudinal cross section through a sensor portion 405 of the fibre optic cable 404 and FIG. 6b shows a view from above of a part of the length of fibre optic cable 404 again showing sensor portion 405. As previously explained the fibre optic cable comprises an inner core 406, typically around 5 μm in diameter for a single mode fibre, surrounded by a glass cladding 408 of lower refractive index around the core, the cable also generally being mechanically protected by a casing 409, for example comprising silicon rubber and optionally armour. The total cable diameter is typically around 1 mm and the sensor portion may be of the order of 1 cm in length. As can been seen from FIG. 6 at the sensor portion of the cable the cladding 408 is at least partially removed to expose the core and hence to permit access to the evanescent wave from guided light within the core. The thickness of the cladding is typically 100 μm or more, but the cladding need not be entirely removed although preferably less than 10 μm thickness cladding is left at the sensor portion of the cable. It will be appreciated that there is no specific restriction on the length of the sensor portion although it should be short enough to ensure that losses are kept well under one percent. It will be recognized that, if desired, multiple sensor portions may be provided on a single cable.

For a Dove prism the characteristic penetration depth, dₚ, of an evanescent wave, at which the wave amplitude falls to l/e of its value at the interface is determined by:

$${d}_{p} = \frac{λ}{2 {π ( {( sin ( ϑ ) )}^{2} - {n}_{12}^{2} )}^{\frac{1}{2}}}$$

where λ is the wavelength of the, θ is the angle of incidence at the interface with respect to the normal and n₁₂ is the ratio of the refractive index of the material (at λ) to the medium above the interface. A similar expression applies for a fibre optic. Generally dₚ is less than 500 nm; for a typical configuration dₚ is less than 200 nm, often less than 100 nm.

A sensor portion 405 on a fibre optic cable may be created either by mechanical removal of the casing 409 and portion of the cladding 408 or by chemical etching. FIGS. 7a and 7b demonstrate a mechanical removal process in which the fibre optic cable is passed over a rotating grinding wheel (with a relatively fine grain) which, over a period of some minutes, mechanically removes the casing 409 and cladding 408. The point at which the core 406 is optically exposed may be monitored using a laser 702 injecting light into the cable which is guided to a detector 704 where the received intensity is monitored. Refractive index matching fluid (not shown in FIG. 7a) is provided at the contact point between grinding wheel 700 and table 404, this fluid having a higher refractive index than the core 406 so that when the core is exposed light is coupled out of the core and the detected intensity falls to zero.

FIG. 7b shows a graph of light intensity received by detector 704 against time, showing a rapid fall in received intensity at point 706 as the core begins to be optically exposed so that energy from the evanescent wave can couple into the index matching fluid and hence out of the table. With a chemical etching process a similar procedure may be employed to check when the evanescent wave is accessible, that is when the core is being exposed, by removing the fibre from the chemical etch ant at intervals and checking light propagation through the fibre when index matching fluid is applied at the sensor portion of the fibre. An example of a suitable enchant is hydrofluoric acid (HF).

FIG. 8 shows a simple example of an application of the apparatus of FIG. 4a. Fibre optic cable 404 and sensor 405 are immersed in a flow cell 802 through which is passed an aqueous solution containing a chromophore whose absorbance is responsive to a property to be measured such as pH. Using the apparatus of FIG. 4a at a wavelength corresponding to an absorption band of the chromophore very small changes, in this example pH, may be measured.

The above described instruments may be used for gas, liquid and solid phase measurements although they are particularly suitable for liquid and solid phase materials. Instruments of the type described, particularly those of the type shown in FIG. 1c may operate at any of a wide range of wavelengths or at multiple wavelengths. For example optical high reflectivity are mirrors available over the range 200 nm-20 μm and suitable light sources include Ti:sapphire lasers for the region 600 nm-1000 nm and, at the extremes of the frequency range, synchrotron sources. Instruments of the type shown in FIG. 4a may also operate at any of a wide range of wavelengths provided that suitable fibre optic cable is available.

### Evanescent Wave Sensing

We will now describe some aspects of fibre cavity design and sensors based upon instruments/apparatus employing a fibre optic cavity.

Implementation of evanescent wave cavity ring-down spectroscopy (e-CRDS) in a rugged field instrument is facilitated by construction of the optical resonator within a fibre optic. This effectively makes alignment automatic and makes the cavity robust but highly flexible. The choice of fibre optic and wavelength of operation is controlled by the optical loss budget with the cavity to enable the e-CRDS ring-down technique to be implemented and, for functionalised surfaces, the design of the absorption specific chemistry for the preparation of these surfaces. The loss budget for the optical resonator determines the ultimate sensitivity of the technique together with the ability to determine the losses from each component in the fabrication of the cavity.

As a preliminary we outline techniques for the preparation of functionalised surfaces; these are described in more detail in the Applicant's co-pending UK patent application entitled Functionalised Surface Sensing Apparatus and Methods, filed on the same day as this patent application, the contents of which are hereby incorporated by reference in their entirety.

Broadly speaking, and as described above, reflection from a totally internally reflecting (TIR) surface generates an evanescent wave to provide a sensing function, and the TIR surface is provided with a functionalising material over at least part of its surface such that the evanescent wave is modified by the functionalising material so that an interaction between the functionalising material and a target to be sensed is detectable as a change in absorption of the evanescent wave and hence a change in the ring-down characteristics (time) of the cavity. The functionalising material may, for example, be a host for a guest species or ligand, and in preferred arrangements comprises a chromophore (to provide absorption at a wavelength of operation of the apparatus). The functionalising material may be attached by means of a molecular tether or link; where the TIR surface comprises silica the tether may be attached by a Si—O—Si bond.

Further understanding of the way in which a sensor surface may be functionalised may be gained by considering the example of a pH sensor based upon the Nile Blue chromophore (absorbing at 637 nm). A tether can be attached to this, as shown in FIG. 9, by refluxing with 3-aminopropyltriethoxysilane in methanol solution to form a silyl functionalised Nile Blue derivative as illustrated. FIG. 10 shows a schematic diagram of the chrompohore attached to a sensor surface to provide a pH sensor. The tether has a triethoxysilane group that forms a Si—O—Si bond at the surface to bind the species to the surface. The ethoxy group acts as a leaving group when the silicon undergoes nucleophilic attack by the surface silanol group. The OEt leaving group can be replaced with a chloro group producing a chlorosilane derivative with different tethering properties. The tethering process can be varied to provide 1, 2 or 3-OEt or —Cl on the tethered molecule to establish 1, 2 or 3 anchoring points to the surface or the formation of a cross-linked surface polymer chain. The skilled person will appreciate that using these general techniques many different functionalisations may be applied to an evanescent wave surface of a cavity ring-down sensor, either one functionalisation per surface (in a multi-surface sensing apparatus, as described further below) separately or in combination at a single sensing surface.

We now describe fabrication details of some fibre optic cavities.

Fibre optic was purchased from Oz Optics (Ontario, Canada) with a minimum absorption at 633 nm specified at 7 dB km⁻¹. The losses at 633 nm are dominated by the absorption losses of the silica in the fibre and a shift to longer wavelength can allow the operation of the cavity in a region of lower losses in the absorption spectrum of the silica. The minimum absorption occurs at 1.5 μm, the telecom wavelength. The specification for the fibre is shown in Table 1 below.

TABLE 1
Fibre specification INO 601A

| | |
|---|---|
| Losses/dB km⁻¹ | 7 |
| Numerical Aperture | 0.11 |
| Core Diameter/μm | 5.6 |
| Cladding Diameter/μm | 125 |
| Optimised Wavelength/nm | 635 |
| Cut off Wavelength/nm | 540 |

The fibres were fabricated in two batches, one supplied and prepared with high-reflectivity mirror coatings by INO(Institute National d'Optique—National Optics Institute; Quebec, Canada), and one supplied by Oz optics with high-reflectivity mirror coatings provided by Research Electro Optics (REO), Inc, of Colorado, USA. Each fibre was polished flat as part of a standard INO preparation procedure and then connectorised with a standard FC/PC patchchord connector. For the REO batch the mirror coatings were applied to the end of the polished fibre with the FC/PC connectors in place. The fabrication process may coat the mirrors before or after connectorisation. The batch from INO was supplied as patch-chords with a rugged plastic covering around the fibres (likely added after the mirrors were coated); the batch sent to REO had no outer coating, except the silicone covering, around 1 mm in diameter to minimise out-gassing during the coating processes.

Two mirror reflectivity custom coating runs were performed, by Oz Optics and by REO. Oz specified a coating reflectivity of better than 0.9995; REO specified 0.9999 or better reflectivities by their standard processes. These mirror coatings reflectivities are manufacturer's estimates.

Fibre optic tapers were prepared under contract by Sifam Fibre Optics, Torquay, Devon, UK, tapering the fibre optic revealing some of the evanescent wave, as described above, allowing it to couple to molecules in the outside medium. This was measured with a solution of crystal violet (CV⁺), which has an absorbance at 633 nm —CV⁺ placed on the surface of the taper absorbs the radiation from the evanescent field and this is seen as a loss in the intensity of the radiation in the fibre, as shown in the graph of induced loss against taper waist (corresponding to extension) shown in FIG. 13.

The fibre of Table 1 has a “W” index profile which leads to increased losses in the tapering process, and therefore tapers were drawn in the fibre specified in Table 2 below, which has a simple step index profile. A tapered fibre was then spliced into a cavity to provide an overall cavity length of 4.2m; more than one taper could be spliced into a cavity in a similar way. The cavity length was chosen to be this length to increase the ring down time τ (which has a linear dependence on tᵣ the round trip time). To reduce the splicing losses the mirrors may be deposited onto a fibre with a desired index profile.

TABLE 2

| Fibre Lot ID | CD01875XA2 |
|---|---|
| Cladding Diameter/μm | 124.72/125.51 |
| Coating Diameter/μm | 248.77/248.9 |
| Attenuation at 630 nm/dB km⁻¹ | 7.09 |
| Cutoff/nm | 612.4/619.5 |
| Mean Fibre Diameter at 630 nm/μm | 4.28/4.62 |

Observed ring down times, τ, for a selection of un-tapered fibre cavities (fabricated and coated by Oz Optics) are given in Table 3 below; FIG. 11 shows a ring-down trace for cavity FC2. This was captured using a digital oscilloscope and averaged 256 times at a repetition rate of 8 KHz and then input to a signal processor (personal computer) which fitted a single exponential using a standard (non-linear) Levenberg-Marquardt procedure.

TABLE 3

| Cavity | Cavity Length/m | τ ± σ/μs | Comments |
|---|---|---|---|
| FC1 | 2 | 1.23 ± 0.023 | Oz Optics Fibre and |
| | | | Mirrors στ/τ = 0.96% |
| FC2 | 2 | 2.176 ± 0.033 | Oz Optics Fibre and |
| | | | Mirrors στ/τ = 1.29% |
| FC3 | 1 | 0.823 ± 0.013 | Oz Optics Fibre and |
| | | | Mirrors στ/τ = 1.58% |
| FC4 | 1 | 1.050 ± 0.015 | Oz Optics Fibre and |
| | | | Mirrors στ/τ = 1.43% |
| FC5 | 1 | 0.538 ± 0.065 | Oz Optics Fibre and |
| | | | Mirrors στ/τ = 1.20% |
| FC6 | 1 | 0.402 ± 0.025 | Oz Optics Fibre and |
| | | | Mirrors στ/τ = 0.61% |
| FC7 | 2 | 1.870 ± 0.023 | Oz Optics Fibre and |
| | | | Mirrors στ/τ = 1.22% |
| FC8 | 2 | 0.801 ± 0.028 | Oz Optics Fibre and |
| | | | Mirrors στ/τ = 3.54% |

The CRDS technique facilitates measurements of fibre optic propagation and fabrication losses. Measurements of the effect of bending on a fibre cavity are summarized in Table 4 and shown in FIG. 12. Conventionally the bend radius of a fibre is the minimum radius at which the fibre should be bent to avoid significant propagation losses; a typical radius is ˜2 cm.

An evolving τ trace is shown in FIG. 12, with ring-down time τ on the y-axis and time on the x-axis. After 40 time points the fibre was bent in half, which resulted in a measured τ of less than 50 ns. Bending the fibre with a 2 mm bend radius resulted in a τ of ˜0.73 μs (a loss of 0.058 dB). Subsequent bends were formed by wrapping the coated fibre around a 8 mm diameter former, making up to 5 turns, and FIG. 12 shows the resulting stepwise increase in losses associated with each successive turn.

TABLE 4

| Bend Radius/mm | τ/μs | Δτ (τ₀ = 2.176) | Observed Loss/dB |
|---|---|---|---|
| 0 | 2.176 | 0 | 0.019 |
| 2 | 0.731 | 1.445 | 0.058 |
| 4 × 1 turn | 2.033 | 0.143 | 0.0018 |
| 4 × 2 turns | 1.980 | 0.196 | 0.0023 |
| 4 × 3 turns | 1.884 | 0.292 | 0.0034 |
| 4 × 4 turns | 1.552 | 0.624 | 0.0082 |
| 4 × 5 turns | 1.471 | 0.705 | 0.0097 |

We turn next to the fabrication of tapered cavities. The telecoms industry has developed a technology for fusing fibre optics together, coupling two or more input fibres into one output fibre. This achieved by tapering the fibres and fusing the cores of the incoming fibres to the output fibre. In tapering a single fibre optic some of the evanescent field is revealed from the core and samples the region outside the taper—this is the basis of the tapered fibre cavity.

Tapered fibre cavities may be made by pulling under heating to a known radius to produce the taper, for example by Sifam, as mentioned above. The taper may then be spliced into a fibre cavity to form a complete sensor, as shown in FIG. 14. The observed losses for a taper prepared with INO fibre are large due to the “W” shaped refractive index profile of these fibres and instead a step index profile fibre is preferable; this may then be spliced into an INO fibre cavity. The tapered region may be supported in a ‘U’ shaped gutter. In an alternative fabrication technique mirrors are deposited onto a fibre that is appropriate for tapering; losses of the taper may then be monitored by CRDS during the taper preparation.

FIG. 13 shows results of experiments performed to investigate the evanescent wave coupling to crystal violet as a function of taper diameter. The experiments were performed in the presence of crystal violet (CV) 122 μM at pH 8.6, chosen to maximise the binding of CV to the (charged) silica surface. The results show that losses are tolerable for tapers of diameter 25-30 μm.

The measured ring-down times and losses for each of four tapered fibre optic cavities are shown in Table 5—EV1 and EV2 are cavities prepared from INO fibre with REO mirrors specified at R=0.9999; EV3 and EV5 comprise INO fibre and mirrors specified at R=0.9995—EV3 and EV5 have signal intensities from a photomultiplier (PMT, 50ω termination) of the order 40 mV whereas EV1 and EV2 have a signal intensity of order 7 mV.

TABLE 5

| Fibre | Taper Length/ | Estimated | | Observed Loss/ |
|---|---|---|---|---|
| Cavity | mm | Loss/dB | Observed τ/ns | dB |
| EV1 | 16.15 | — | 114 ± 1.7 | 0.86 |
| EV2 | 16.42 | 0.01 | 129 ± 7 | 0.75 |
| EV3 | 16.70 | 0.02 | 300 ± 3 | 0.31 |
| EV5 | 16.78 | 0.01 | 337 ± 15 | 0.27 |

We next consider fibre cavity losses.

The losses in fibre optic are measured in decibels (dB) per kilometer, with the dB defined by the following equation:

$$dB = 10 {log}_{10} ( \frac{{P}_{i n}}{{P}_{out}} ) \qquad ( 6 )$$

where Pᵢₙ and Pₒᵤₜ are the input and output powers respectively. The losses in CRDS experiments are measured by the ring-down time, τ, with contributions from:

Iₙ=(R(v)T_{f}Lᵢ exp(−α(v)l))²ⁿI₀ (7)

Where R(v) is the frequency dependent reflectivity of the mirrors, T_{f} is the transmission loss of the fibre and Lᵢ are all other losses to include scatter and diffraction effects. The absorption of any molecular species within the cavity is assumed to follow Beers Law with l being the length of the cavity and n is the number of bounces. Absorption within the evanescent field will also be by Beers law but with an effective penetration depth for the radiation, d_{c}, and a concentration profile. Equation 7 can be re-arranged to give:

Iₙ=exp(−2n(α(v)l−1nR−1nT_{f}−1nLᵢ))I₀ (8)

Transforming to the time variable t=2nl/c, where c is the speed of light and l is the length of the cavity, the expression now shows the expected form for the exponential decay of radiation intensity within the cavity:

$$I ( t ) = exp ( - \frac{ct}{l} ( α ( v ) l - ln R - ln {T}_{f} - ln {L}_{i} ) ) {I}_{0} \qquad ( 9 )$$

The ring down time of the cavity, τ, is given by:

$$τ = \frac{{t}_{r}}{2 ( α l - ln ( R ) - ln ( {T}_{f} ) - ln ( {L}_{i} ) )} \qquad ( 10 )$$

where tᵣ is the round trip time of the cavity. Using the Taylor series approximation −1n(R)≈(1−R) at R=1, the conventional equation for the losses of an empty free-space cavity with losses dominated by the mirror reflectivities can be recovered:

$$τ = \frac{{t}_{r}}{2 ( 1 - R )} \qquad ( 11 )$$

where tᵣ is the round-trip time and R is the mirror reflectivity.

The Taylor series expansion is a good approximation for R=0.9999 with −1n(R)−(1−R)=5×10⁻⁹, five parts in a billion. With R=0.999, the difference is 5×10⁻⁷, or five parts in 10 million and for R=0.99, the difference is 5×10⁻⁵, five parts in 100 000. So for all calculations with fibre cavities this is a good approximation.

Considering now non-tapered fibre cavity losses, the losses in the fibre cavities without the tapers have an exponential decay with a ring down time given by:

$$τ = \frac{{t}_{r}}{2 ( ( 1 - R ) + ( 1 - {T}_{f} ) + ( 1 - {L}_{i} ) )} \qquad ( 12 )$$

With a cavity of 2m in length and a specified fibre loss of 7 dB km⁻¹, R=0.9995 and Lᵢ=0, the predicted ring down time of the cavity is (all calculations of losses are per round-trip with a silica refractive index of 1.4601):

$$τ = \frac{\frac{2 \times 2}{c} \times 1.4601}{2 ( ( 5 \times {10}^{- 4} ) + ( 1 - {10}^{- \frac{7 \times 4 m}{{10}^{4}}} ) )} \\ τ = \frac{1.9533 \times {10}^{- 8}}{2 ( ( 5 \times {10}^{- 4} ) + 6.426 \times {10}^{- 3} )} \\ τ = 1.410 µs \qquad ( 13 )$$

This compares with the measured cavity τ=1.23±0.025 μs (for FC1). Hence the fibre transmission losses dominate the losses in the cavity and determine the ring down time. There are still some additional losses that are not accounted for by the 7 dB km⁻¹ loss for the fibre and the effective fibre losses are 8.6 dB km⁻¹ (cf FC2 where τ=2.176 is consistent with effective fibre losses of 4 dB/km). This may be because fabrication of the high reflectivity mirrors on the end of the fibre may not be as easy as expected and the observed mirror reflectivities may be lower than the specified 0.9995. Dropping the mirror reflectivities to 0.999 gives a limiting value of τ=1.315 μs. The discrepancy in the mirror reflectivity and the estimate of the fibre loss are all very close to the observed limiting loss and can easily be explained in terms of fabrication losses (under specification mirrors, uncertainty in the loss parameter)—it should therefore be possible to improve upon these. It is noted that the batch of cavities performs, without optimisation, to within 12% of the specified limit.

Considering now tapered cavity losses, the observed ring down time for spiced cavities 4.2 m long was 300±0.02 ns, which corresponds to a round-trip loss of 7.72×10⁻² or 7.7% (0.3 dB). Hence the fibre transmission, including the two splices and the taper is 0.9274.

Measurements with a high index liquid (1.51) show a drop in the ring down time of the cavity consistent with the presence of an evanescent field within the taper. The losses from the taper and the splices are clearly significant, more than was estimated from the matching of the external diameters of the fibres, 0.04 dB. This figure produces an estimated loss, per round trip including a total of four passages through the splices, 3.6%, indicating the splicing and taper losses are larger than predicted.

We now examine some considerations for fibre optic sensor networks, first considering fibre cavity losses for long cavities.

Extrapolating the loss analysis for non-tapered cavities, the fibre propagation losses dominate the cavity loss and hence it is possible to predict the losses of the cavity as a function of cavity length. For fibres with transmission losses of 7 dB km⁻¹, R=0.9995 the variation of ring-down time τ in microseconds with optical cavity length in metres is shown in FIG. 15. The ring down time, τ, increases by 26% from a 1 m cavity to a 100 m cavity. This strongly suggests that long fibre cavities may be deployed without significant loss of sensitivity and opens the potential for fibre optic cavity networks.

A fibre optic cavity may be fabricated with a broadband mirror. The ring down time and hence the sensitivity of fibre based e-CRDS is determined by the propagation losses in the fibre and the production of the taper. The losses in the fabrication of a single taper have yet to be determined but appears that the mirrors are not the limiting factor. This enables the reflectivity specification to be lowered to values around 0.999. Mirror production techniques allow the preparation of broadband very high reflectivity coatings over a wavelength region of at least 500-1000 nm. This enables radiation of different wavelengths to propagate along the same cavity, for example to interrogate different sensor regions.

Wavelength division multiplexing (WDM) in fibre optics is a well established technique in the telecoms industry and wdm coupler and switch technology can be employed to couple multiple wavelengths into a common cavity for parallel detection scenarios. For example switching of radiation of different colours, say red, green and blue, can be straightforwardly incorporated into a fibre network design, as shown schematically in the fibre sensor network 1600 of FIG. 16. Referring to FIG. 16, a fibre cavity 1602 includes one or more tapered regions to provide one or more evanescent wave sensing surfaces and hence a network of sensors. Light at a plurality of wavelengths, for example red, green and blue light from laser diodes or other sources, is coupled into the cavity by wdm light source 1604 and cavity ring-down is monitored by amplifier 1606, for example comprising a fibre amplifier, and console 1608. Console 1608 may comprise, for example, a wavelength division demultiplexer coupled to one or more PMTs (each) having a digitised output, these signals being provided to a computer programmed to determine cavity ring-down time at each of the wavelengths and hence to determine a (change in) cavity loss at the relevant wavelength (as described above) to provide a combined sensed signal/data output or plurality of sensed signal/data outputs. Console 1608 may also provide centralised monitoring/command/control of the sensor network.

Molecules absorbing at different wavelengths can be used to construct smart or functionalised surfaces either for monitoring the change of the same species or of different target species with the same cavity. For example haemoglobin has absorptions at 425 nm (due to the iron) and at 830 nm (due to the prophyrin ring) and can be used to functionalise a surface to sense oxygen, CO, and/or NO. In embodiments parallel detection of the same target using different functionalising molecules (absorbing at different wavelengths) allows measurements to be compared/combined, for example for increased confidence in detection or for a confidence limit assessment to be made. In one application a multiplexed fibre optic network of sensors working at different detection wavelengths is deployed in a public place or around (within) a building, vessel, or other structure. For example such a multiplexed sensor network may be used to monitor carbon dioxide level(s) in the air of a submarine.

We now consider the operation of free-running cavities, as described above, in more detail. As previously mentioned a free-running cavity structure allows a broad bandwidth cw laser to overlap with many cavity modes so that radiation will always enter the cavity. The observed ring down profile is then a convolution of the ring down of several modes each in principle with the own, slightly different τ. Each τ will depend on how flat the mirror reflectivity curve is over the bandwidth of the laser and whether there are any frequency dependent losses (e.g. diffraction losses) that are significantly different over the bandwidth of the laser. The free-running cavity allows the laser to be chopped at, for example, 10 kHz, which may be averaged to improve the noise statistics. With a stable cavity, the ring-down time shows a deviation error, Δτ/τ<1%, which determines the ultimate absorbance sensitivity of the fibre cavity technique.

The absorbance by a species in the cavity is related to the cavity length (the round-trip time) and the minimum detectable change in τ, the ring down time given by the formula:

$$Abs = \frac{Δ τ}{τ} \frac{{t}_{r}}{2 {τ}_{0}} \qquad ( 14 )$$

Work to date suggest that estimates of Δτ/τ are not generally better than 1% and the detection sensitivity is thus given by the round-trip time and τ of the empty cavity, τ₀. The minimum detectable absorbance for the fibre cavity, 1 m long, is 4.3×10⁻⁵ this provides a two-fold improvement in sensitivity compared with a bench top Dove cavity with a minimum detectable absorbance limit of 7.4×10⁻⁵. The calculation for the fibre cavity assumes the observed ring-down time of 1.23 μs but this may be improved upon by optimising the fabrication.

We now consider cavity modes: The longitudinal modes of a cavity are dependent on the length of the cavity with the separation between the modes known as the free spectral range (FSR), as illustrated in FIG. 17. For a 2m fibre cavity the FSR (n=1.4601):

$$δ v = \frac{nc}{2 l} \\ δ v = \frac{1.4601 \times 2.99 \times {10}^{8}}{4} = 109 MHz \qquad ( 15 )$$

For a cavity 100 m long the separation FSR becomes 2.1 kHz. The power intensity within a free-running cavity depends on the overlap of the input radiation with the cavity modes. The free-running cavity overlaps at least two modes, one FSR, and so light will always couple into the cavity. The output profile of a laser is generally rather broad, of order 5 nm, and so generally only a fraction this will couple to the cavity.

Coupling light into the cavity depends both on the number of longitudinal modes overlapped by the input light source and the width of the modes. The full width half max (FWHM) of each mode is controlled by the cavity finesse as defined below.

Considering now cavity finesse and Q-factor, the width of the modes in FIG. 17 is controlled by the finesse of the fibre cavity is given by:

$$F = \frac{π \sqrt{R}}{( 1 - R )} \qquad ( 16 )$$

For a 0.9995 cavity dominated by the mirror losses, the finesse of the cavity is 3140. If R is replaced by the general round trip loss for the fibre cavity, (0.9921) then the finesse of the fibre cavity is 396.

The Q-factor may be defined by equation 17 below, which for the fibre cavity takes the value 395.7—in close agreement with the calculated cavity finesse.

$$Q = \frac{2 π τ}{{t}_{r}} \qquad ( 17 )$$

From the relation Finesse=FSR/FWHM, the calculated FWHM for the modes in the fibre cavity is 275 kHz, and thus in a long cavity modes overlap to effectively provide a “white light” cavity into which light over a continuous range of wavelengths can be coupled.

In the configurations discussed above multimode fibres may be used as an alternative to single mode fibre, and a range of different index profiles may be employed to give a range of taper configurations. In some preparation processes tapers may be prepared in situ with a mirrored fibre so the losses can be monitored as the taper is pulled; this may be used to optimise the ring down time with the taper present in the cavity. Also, as mentioned, different taper thickness may be drawn to control the amount of evanescent field present outside the fibre and hence interaction with sensor molecules. Controlling the taper thickness can also be used to adjust the dynamic range of the sensor. Changing (increasing) the length of the taper changes (increases) the interaction length for the sensor surface and this can increase the sensitivity of a sensor. The networking potential for the sensors has been established, with cavity lengths of up to 100m or more.

It appears that in some circumstances there is an advantage in moving to longer wavelengths to those used for the experiments described above. For example, increasing the detection wavelength from 639 nm to 820 nm or longer has the potential to reduce propagation losses within a fibre. Light sources are available at high power both at 820 nm and 1.5 μm, products of the telecommunications industry and the fibre transmission losses are generally much lower at 820 nm, ˜2 dB km⁻¹ giving ring down time for a 2 m cavity of 4.1 μs and a round trip transmission of 0.997. Thus loss is still dominated by the fibres at 820 nm and the mirror losses do not need to be better than 0.999. At 1.5 μm the fibre losses are 0.18 dBkm⁻¹ and for a 2 m cavity give a cavity ring down time τ of 14.7 μs with a round trip transmission of 0.9993. Mirror reflectivity now becomes important and a cavity operating at this wavelength would preferably employ a 0.9995 or better mirror specification. At each wavelength the cavity parameters changes and the power and detection characteristics can be balanced by routine experiment. Calculation of the minimum detectable absorbance change using equation 14 suggests that the detection limit at 820 nm will be nearly 4 times better than at 639 nm and at 1.5 μm, some 10 times better than at 639 nm. Hence an 820 nm cavity will have a detection sensitivity of order 2×10⁻⁵. The skilled person will recognise that fibre optic e-CRDS will work within any fibre optic of tolerable transmission loss (of order 8 dB km⁻¹).

A longer wavelength than 639 nm, say ˜800 nm, may be used for example with a “dirty bomb” sensor surface as the molecule to which the target binds, isoamethyrin, (targets comprise actinyls such as UO₂²⁺, PuO₂²⁺, NpO₂²⁺) have an absorption maximum at approximately 830 nm. More generally a functionalising molecule may employ an extended porphyrin structure to tune the molecular electronics into this region of the spectrum. Liquid phase absorption spectra at 1.5 μm (6666 cm⁻¹) tend to be dominated by overtone absorptions but gas phase absorption occurs at these wavelengths, in particular CH₄ and CO₂, which may be employed for monitoring submarine environments. In a simple arrangement the target molecule is required to land on the silica surface before detection, but the collision with the surface is directly proportional to the gas phase concentration. Longer wavelength radiation may also be employed with a suitable chromophore. For example, infrared chromophores tuned at 1.5 μm can be designed to allow the much lower transmission losses of silica at this wavelength to be exploited.

There are many other vibrations in the mid infrared which can be used, such as 1150 nm for the first overtone of the —CH₃ group in molecules and the 1400 nm —CH₂ combination band, which has been used the octane number of gasoline and which is of relevance to the petrochemical industry. The near IR and mid IR regions of the spectrum have potential for monitoring the properties of a collection of C, N, O, H species, for example for applications in industries such as the food and drink industry. Also, an e-CRDS sensitivity of order 10 ppm in absorbance offers potential for lower detection levels and tighter tolerances in the specification of aviation fuel.

The above described fibre optic-based or more generally waveguide-based CRDS systems may be employed to provide a range of sensor systems. Broadly speaking such sensor systems fall into two classes, intrinsic sensors based on losses in a fibre or a change in fibre properties in response to the surrounding environment, and extrinsic sensors (e-CRDS) where something is added to the surface of the fibre that will interact with a target or demonstrate an interaction with changing properties.

In general, in such a sensor system an output from a ring-down detector such as a PMT responsive to a light level within the cavity is digitised and provided to a signal processor such as a general purpose computer system, programmed in accordance with the above equations to determine a cavity ring-down time and hence a cavity loss. This information may be output directly (either as an output signal from the computer or as data written to a file or provided by a network connection) or further processing may be applied to determine a sensor signal representing, for example, a change in a sensed parameter such as a level of a target species present.

Depending upon the sensor configuration a wide range of information is available with this technique. For example, one or more intrinsic properties of a fibre used to form the cavity may be determined or, where a portion of a fibre included within the cavity is bent, changes in the cavity loss at the bend due to a change in say pressure, may be very sensitively monitored. In other arrangements the losses in the fibre may be sensitive to an external variable such as temperature or electric or magnetic field; in such arrangements it is often preferable that the fibre is doped to increase the desired sensing response. Where the light level detecting arrangement is able to resolve one or a group of individual light pulses bouncing to and fro within the cavity (for example using the Hammatsu H7732 photosensor module and fast oscilloscope mentioned above) then time-resolved sensing is possible with a very fine time granularity, for example better than 100 ns or better than 10 ns for a short cavity. Thus applications for the above described CRDS techniques include (but are not limited to) sensors to measure stress, strain, temperature, pressure, to act as hydrophone arrays, magnto-optic sensors, electro-optic sensors, flow sensors and displacement sensors. In addition to this a “smart” or functionalised sensor surface may be employed to provide chemical/biological sensors benefiting from the above described CRDS techniques.

### Evanescent Wave Fluid Monitoring

We now describe techniques for monitoring fluids, in particular critical fluids with specific reference to oil, and apparatus for sensing/monitoring a fluid's complex refractive index.

The preparation of a tapered fibre allows the evanescent wave to explore a region of the medium above the fibre substantially equal to the penetration depth. The penetration depth is of order λ where λ is the wavelength of the radiation and hence for the wavelengths mentioned above the penetration depth will be of order 600-1000 nm.

In a conventional absorbance experiment the path length for optical absorbance is typically 1 cm making it impossible to make direct absorbance measurements for optically thick samples. The tapered fibre configuration whether used as a single pass or multi-pass within an optical cavity is sensitive to refractive index, formally the complex refractive index, over a much shorter path length. This offers the potential for a fibre optic dipstick that can be placed within any medium to monitor the colour or the colour change of a sample. Initial, single-pass experiments demonstrated sensitivity to colour change in engine oil at 100° C. We describe further, more detailed experiments below. The techniques have applications for monitoring the condition of a fluid, in particular a fluid critical to the proper performance of a system, such as engine oil, turbine lubricant, gearbox lubrication, and hydraulic fluid, by monitoring the change in the complex refractive index detected by a tapered fibre or other evanescent-wave cavity.

We will describe below measurements that demonstrate the use of an optical property or properties of a fluid as a diagnostic of the condition of the fluid. These measurements and techniques, for example implemented using systems similar to those described above, can provide technology for on-line, real-time, in situ monitoring of critical fluids.

Measurements of temperature induced degradation of an engine oil show a clear variation of the visible spectrum with time that is diagnostic of the length of heating. Furthermore measurements of the spectrum of oil from an automotive engine as a function of general use mileage show a transition from absorption to particulate dominated scatter after 750 miles. The degree of scatter in the optical spectrum is diagnostic of the mileage of the car. Measurements using a fibre optic dipstick have shown a response to this change in situ and in real-time at 110° C., reporting the results to a control panel. The optical density of the fluid increases 5-fold in less than 100 miles. However control of the optical interaction with the fluid enables high-optical density fluids to be monitored and this is demonstrated for crude oil feed and vistar oil samples.

Monitoring of the condition of specialist fluids including lubricating fluids and hydraulic fluids in situ presents an interesting problem in engineering performance optimisation and is best served by an on-line sensor system. Possible applications include: aero gas turbine (GT) engines in military and civil applications; aircraft transmissions (in particular helicopters); gas generators where lubricating fluids are subject to physical and chemical degradation; automotive engine, transmission and hydraulic systems; crude oil vacuum distillation and initial cracking towers of refineries.

Improvements to the materials in these environments such as the use of carbide steels, allow the performance of the systems to be stretched but this is now pushing the lubricating fluids to the limit of their operating envelope. Current practice requires the system to be closed down for regular routine maintenance but a desirable alternative is on-line monitoring.

We describe optical monitoring of lubricants in a controlled temperature degradation experiment and regular sampling from the sump of an automobile, a Mazada 323F, during routine use. Further experiments on two optically dense fluids, feed stock and vistar (post cracking oil), have also been performed at elevated temperatures demonstrating the control of optical path length. The above-described apparatus can be used for monitoring such fluids.

A number of commercially available lubricants were tested (see Table 6 below) to acquire background information regarding their refractive index, absorption and fluorescence characteristics. The absorption spectra of the clean oils (as supplied) were measured over the wavelength range from 190-900 nm and are dominated by an absorbance below 370 nm attributed to the absorption of the aromatic ring structure of the hydrocarbon species within the oil. The values given are ‘simple’ refractive index values for new, clean and clear oils which have not been subject to fouling or degradation (apart from the Jet Oil 2), and provide a base line set of easily obtainable optical measures. The Jet Oil 2 was not “new” and worked for over 1000 hours within a small Centrax engine system. Some automotive fluids are dyed to identify their applications and the absorption spectra of the dye is clearly visible. The automatic gearbox fluid and synthetic gear oil have strong absorbance around 525 nm and thus are dyed red; specialist hydraulic fluid absorbs in the blue (453-476 nm) and the red (600-650 nm) and thus is dyed green. IR spectroscopy of these fluids shows a characteristic but non-diagnostic absorbance associated with the —CH functionality of these compounds.

TABLE 6

| | | | RI |
|---|---|---|---|
| Lubricant | Application | Supplier/User | (589.3 nm) 25° C. |
| Eurodiesel 15W-40 | Automotive Engine | Comma/Automotive | 1.4782 |
| Syner-G 5W-40 | Automotive Engine | Comma/Automotive | 1.4672 |
| Eurolite 10W-40 | Automotive Engine | Comma/Automotive | 1.4755 |
| Europa 15W-50 | Automotive Engine | Comma/Automotive | 1.4780 |
| GTX Magnatec 10W-40 | Automotive Engine | Castrol/Automotive | 1.4759 |
| R-40 | Automotive (Race) Engine | Castrol/Automotive | 1.4761 |
| ATF (AQM) | Automotive Transmission | Comma/Automotive | 1.4742 |
| | (Automatic) | | |
| EP80 | Automotive Transmission | Comma/Automotive | 1.4839 |
| EP90 | Automotive Transmission | Comma/Automotive | 1.4823 |
| SX75W-90 (Synthetic) | Automotive Transmission | Comma/Automotive | 1.4721 |
| DOT 3 | Automotive Brake | Comma/Automotive | 1.4424 |
| LHM⁺ | Automotive Brake/Hydraulic | Bendix/Automotive | 1.4561 |
| Turbo Oil 2380 | Aircraft-Type Gas Turbine | BP/Aircraft GT | 1.4572 |
| | Lubricant | (CENTRAX) | |
| Jet Oil 2* | Aircraft-Type Gas Turbine | Mobil/Aircraft GT | 1.4579 |
| | Lubricant | (CENTRAX) | |

The visible spectrum evolves with the degradation of the fluid showing contributions from scatter of particulates within the fluid. The extinction of the light by particles within the fluid should follow a l/λ⁴ law associated with Rayleigh scatter. The evolution of the absorption spectrum of an engine oil with heating has been observed and is presented below. All measurements were performed using a 1 cm pathlength cuvette within a standard bench-top UV/Visible spectrometer, but can also be made using the CRDS apparatus described herein.

Thermal degradation of an automotive lubricant was set up to give a control experiment where there would be no complication due to the production of ‘soot’ as a result of the exhaust gas bypass (which takes place around the piston rings in a conventional combustion engine). The control experiment involved maintenance of the ‘Eurolite’ 10W-30 engine oil at a temperature above 100° C. for a long period of time (in excess of 1000 hours) with sampling at known intervals. A 1 litre round bottomed boiling flask was set up on a stirrer hot plate and sand bath with the temperature maintained above 105° C. (a common engine sump temperature). As time proceeded, the oil became darker in colour due to oxidation but still maintained its clarity indicating very little particulate formation. The development of the UV/visible spectral tails during this period is shown in FIG. 18. Thus FIG. 18 shows UV/Visible spectra for Eurolite 10W-30 during temperature degradation; with spectra progression at the following times 30 h, 339.5 h, 533 h, 750 h, 871 h and 1102 h.

The variation with temperature can be characterised at two wavelengths which, for operational reasons, are chosen as 637 and 820 nm. The variation is shown in FIG. 19 and it is this output that preferably forms the basis of the optical output of the sensor. Thus FIG. 19 shows variation of absorbance at (▴) 637 nm and (□) 820 nm with thermal degradation. A 1/λ⁴ analysis of these data suggest that the spectra after 1000 hrs of heating are not dominated by scatter.

A program of lubricant degradation tests within an automotive engine was set up to assess the potential of the technology to detect real-time oil degradation. The vehicle (a 1990 Mazda 323F, 1.61, 4 cylinder, petrol) engine was flushed with a proprietary flushing oil and a full oil and filter change using ‘Eurolite’ 10W-30 oil was performed. The fluid was sampled directly from the dipstick port at intervals and UV/Visible spectra measured. The UV/Visible spectra as a function of mileage are shown in FIG. 20.

Thus FIG. 20 shows UV/visible spectra for vehicle oil degradation using Eurolite oil (flushed & changed) at 38 miles, 178 miles, 358 miles, 505 miles, 758 miles, 1011 miles, 1320 miles, and 1680 miles.

The oil shows significant and rapid blackening even after only short journeys of 38 miles, which is clearly seen in the spectra of FIG. 20. Plotting of absorbance vs 1/λ⁴ shows the evolution of the scatter-dominated spectra with good straight lines (R=0.99) observed for 758 miles, (FIG. 21).

Thus FIG. 21 shows absorbance vs 1/λ⁴ showing the evolution of scatter-dominated spectra at 38 miles, 178 miles, 308 miles, 505 miles, 758 miles, 1011 miles, 1320 miles and 1680 miles.

The slope of the straight line may be used as a measure of the particulate concentration within the fluid, FIG. 22. The slope varies rapidly once the particulate nucleation processes start and this is likely to be the onset of oil performance degradation. Thus FIG. 22 shows a plot of straight-line gradient in FIG. 21 vs vehicle mileage, showing oil performance degradation.

The variation in absorbance of the used oil at the two target wavelengths of 637 nm and 820 nm is shown in FIG. 23. Thus FIG. 23 shows variation of absorbance at (♦) 637 nm and (▪) 820 nm in vehicle test oil.

The optical density of the oil clearly increases dramatically after only a few miles of travel and this presents a considerable problem for 1 cm pathlength optical analysis. However, the control of the pathlength sampled by a tapered fibre optic means the rapid increase in optical depth can be monitored directly even when the condition of the oil has become very poor.

The analysis of crude oil during the cracking process requires the monitoring of a very viscous, optically dense material with a high particulate concentration. Preliminary measurements have been performed using conventional desktop absorption spectroscopy with a 1 cm pathlength but require considerable dilution in toluene. An absorption spectrum of a feed (pre-cracking) and vistar (post-cracking) oil sample in toluene (provided by Ondeo-Nalco) has been measured. For each sample, a small amount (50 mg) was dissolved in 5 ml of toluene and a 125 μl aliquot of this was applied to the surface of a cuvette. The solvent was allowed to evaporate, leaving a thin film. The resulting spectra are shown in FIG. 24.

Thus FIG. 24 shows UV/Visible spectra for crude oil and vistar.

The spectra are dominated by a strong absorbance below 400 nm associated with the aromatic ring structure of the hydrocarbon species within the sample. The vistar shows a clear red-shift in the absorbance spectrum (but this may be affected by uniformity of the sample film thickness—each affects are substantially eliminated with a fibre-optic dipstick).

An instrument essentially as described above was constructed from a fibre optic taper designed to work at 635 nm allowing light from a laser to propagate down and back past the sample region. This simple double-pass arrangement provides configuration for testing; a practical embodiment is shown in FIG. 25. Thus FIG. 25 shows a fibre optic dipstick (with a 10 pence piece for scale). The optical path length for the radiation is controlled by the diameter of the taper so that a thicker taper can be pulled for media with high optical density such as the crude oil samples.

The dipstick is encased in a stainless steel tube such as a hypodermic needle and placed directly into the oil sample. The losses of the fibre are monitored in real-time, digitised and returned to a PC, for example via a US bus. The output from the dipstick in the engine oils after 0 and 1680 miles is shown in FIG. 26. Thus FIG. 26 shows variation of a dipstick response for engine oil (Eurolite 10W-30) for clean oil and after 1680 miles. The samples were maintained at 110° C., close to an engine sump temperature. There is a clear and diagnostic difference in the response of the dipstick between the two oil samples with a number of transient features associated with moving between samples.

Similar experiments were performed with the dipstick with crude oil feed and vistar samples. The dipstick is able to produce different responses for the two samples during a heating and cooling cycle from 25° C.-140° C. Thus FIG. 27 shows dipstick responses in crude oil samples of feed and vistar for heating (to the left) and cooling (to the right).

The optical characteristics of oil are a diagnostic of its condition with a direct and obvious transition in the spectrum associated with the scatter of radiation due to particulates—Rayleigh scatter. The technology we have described, allows even highly optically dense liquids to be sampled at elevated temperatures, and is able to provide fluid monitoring on-line and in real time.

FIG. 28a shows the response (arbitrary units) of a fibre optic dipstick according to an embodiment of the present invention monitoring heating and cooling of Castrol R40 racing oil. FIG. 28b shows detail of the transition of FIG. 28a. It can be seen that on heating the refractive index of the oil changes and that at around 72° C. there is a match to the fibre, coupling light out of the fibre.

In some preferred embodiments apparatus is provided which measures a response at between two and four different colours, for example using diode (or other) lasers or LEDs of different wavelengths. Since, as previously mentioned scattering is wavelength dependent (as 1/λ⁴) whereas a change in temperature of the monitored fluid is not wavelength dependent in the same way, by measuring a response at, say, three colours particular scattering effects can be distinguished from temperature change effects. The skilled person will appreciate that there are many ways of making the distinction—for example, the apparatus can be calibrated using a range of fluids with different particulate levels and at different temperatures to provide correction values based on a common (temperature change) response at the different colours.

FIG. 29a shows a typical asphaltene particle. An asphaltene stability test used as a standard in the oil industry. Heptane is added to a toluene or dichloromethane oil dilution and the onset of asphaltene precipitation is observed—asphaltenes are the insoluable part of the oil in heptane. The asphaltene destabilisation test (ADT) is a measure of the carbon content of an oil sample whether from a feed stock or a vista. The extended carbon-ring structure such as shown in FIG. 29a forms a stable suspension in oil and organic solvents such as toluene with high refractive indices but the addition of heptane to the oil or oil dilution results in the destabilisation of the asphaltene suspension and precipitation begins. Adding heptane continuously to a mixture of oil in toluene or dichloromethane, results in a change in the refractive index of the binary mixture which is monitored as a complex refractive index by the taper(s). Example results are shown in FIGS. 29b and 29c which show, respectively, absorbance (y-axis) against complex refractive index x-axis) at 980 nm (upper line) and 635 nm (lower line), and extinction (y-axis) against complex refractive index (CRI) x-axis) at 980 nm (right peak) and 635 nm (left peak). The CRI at which destabilisation occurs is a measure of both the particle size and the local solution refractive index (RI) measured as both RI and scatter by the taper, hence giving a measure of CRI. The CRI is different at the two colours because of the RI properties of the taper—propagation at 980 and 635 nm in the fibre is at different speeds. Hence the 635 light responds to the ADT before the 980 nm. The position and rate of change of the radiation extinction is diagnostic of the CRI of the medium and hence the quality of the oil. The onset in the red is at a lower refractive index from the near infrared as the CRI and fibre refractive indices are different at the two wavelengths. The separation may be employed to calibrate the scale.

It is preferable to determine the CRI from relative losses at one or more different wavelengths. In embodiments the two-pass technique is able to detect CRI changes as small as 5×10⁻⁴ based on a loss change of 0.1% with the smaller tapers. The e-CRDS detection sensitivity should allow CRI changes as small as 10⁻⁶ to be detected. The exact relationship between loss change and CRI depends upon characteristics of the apparatus, in particular the size, diameter, minimum length and profile of the taper dipping in the fluid and on whether we are in the guided or coupled propagation regimes. Thus for some applications calibration of an instrument prior to use may be needed.

Referring to FIGS. 30a and 30b we next describe, as an example, the design of a metal-cased dipstick 900 containing module 901 incorporating a tapered fibre optic sensor surface 902. The outer casing is permeable in the sensor region 904, for example by means of a cage, allowing the sample to enter freely without capillarity and to drain rapidly. The fibre optical pigtailed cable 906 is strained relieved and preferably capable of withstanding significant strain. The entire design is preferably chemically resistant (e.g. hardened) and capable of withstanding a range of operating temperatures.

An example dipstick specification is shown in table 7 below:

TABLE 7

| Item | Specification | | Comments |
|---|---|---|---|
| Dipstick | 1 | m | Overall length from tip to |
| Length | | | connector |
| Operational | 830 | nm | One or many |
| wavelength | | | |
| Mirror | 0.995 | | Cavity, Double pass |
| Specification | | | |
| Taper Length | 20 | mm | |
| Taper | 20 | μm | |
| Diameter | | | |

FIG. 30b shows a fibre optic cavity for the dipstick of FIG. 30a. The fibre optic cavity preferably comprises a continuous piece of fibre 906 without splices tapered and mirrored on each end, M1, M2. The integrity of the fibre cavity, its losses in propagation and taper pulling losses can limit the sensitivity of the technology and should therefore be kept low. The connection efficiency can affect the reproducibility of the results and although a simple FC/PC connector 908 may be sufficient, lower loss connectors are preferable. An example fibre optic specification is shown in table 8 below:

TABLE 8

| Item | Specification | Comments |
|---|---|---|
| Operational Wavelength, λ | 830 | Single or Multimode |
| nm | | option |
| Propagation Loss/dB/km | 7 | Preferably optimized |
| | | for each λ |
| Index Profile | Step | Suits tapering |
| Coating | Polyimide | |
| Outer coating | e.g. PTFE | |
| Overall Length, L/m M1-M2 | 1 ± 0.01 | Directly affects the |
| | | ring-down time |
| Mirror 1, M1 | Flat polished fibre | e.g. ATC coating |
| | (Spec) | |
| Mirror 2, M2 | Flat polished fibre | |
| | (Spec) | |
| Connector, C | FC/PC | Lock fit other spec? |
| Outer protection | Along length | In place for a dipstick |

An example taper specification is shown in table 9 below:

TABLE 9

| Item | Specification | Comments |
|---|---|---|
| Minimum Diameter, D/ | 15 ± 1 | May vary between 10-50 |
| μm | | |
| Length, L/mm | 20 ± 1 | e.g. L for taper <1.5D |
| Profile | Symmetric | Taper region profiled online |
| | | during manufacture |
| Loss in pulling | Loss << 1% | e.g. Measured online |
| Overall length (M1-M2)/m | 1 ± 0.01 | Controlled by the cavity |
| | | length |

Referring to FIG. 31a the module 901 is preferably fabricated from ceramic material such as zirconia or macor. It may be dropped into and secured in the outer dipstick case. This confers flexibility on the design; the core taper module can then easily be incorporated into designs for other applications or markets. The module includes a female 910 at each end of the sensor spaced apart by post(s) 912; it is loaded into a jig and sent for mirror coating, at M1 and M2 for a fibre optic cavity and at M1 only for a two-pass taper.

An example taper module specification is shown in table 10 below, where the reference signs refer to FIG. 31a:

TABLE 10

| Item | Specification | Comments |
|---|---|---|
| Module length ML/mm | e.g. 50 ± 1 | |
| Ferrule 1, FI | | |
| F1L/mm | e.g. 7 ± 1 | |
| F1 Material | Zirconia (grade) | Macor (RTM) |
| F1 - finish | Polished flat with fibre end | |
| M1 | 0.995 | e.g. ATC |
| | | coated |
| Ferrule 2, F2 | | |
| F2L/mm | 7 ± 1 | |
| F2D/mm | 3 ± 1 | |
| F2 finish | Strain relief | |
| Post 1, PI | Length ML-F1L-F2L (1 mm | Or e.g. a tray |
| | thick) | |
| Post 2, P2 | As P1 | |
| Seals, S1, S2 | e.g. Vitrolock (RTM) | |

FIG. 31b shows the module of FIG. 31a incorporated into a dipstick.

The mirrors are preferably specified to maximise the light content of the cavity but to have sufficient reflectivity to be greater than the propagation losses by 10 percent. The ring-down time in the fibre is controlled by the losses of the cavity: 1) propagation loss at target wavelength; and 2) mirror reflectivities. The reflectivity of the mirror also controls the light intensity within the cavity. The fibre propagation loss specification and the mirror reflectivity are preferably specified to be consistent. Preferably the taper module has M1 and M2 coated and then the fibre may optionally be processed by dip-coating smart surfaces as described above onto the taper for target molecule sensing. The dipstick can then be assembled for testing.

An example dipstick specification is shown in table 11 below, which refers to the reference signs in FIG. 31b:

TABLE 11

| Item | Specification | Comments |
|---|---|---|
| Dipstick Length, DL/cm | e.g. 30 ± 0.5 | |
| Dipstick Diameter DD, | e.g. 4 ± 1 | |
| mm | | |
| Tip Length D1/cm | e.g 1 ± 0.1 | |
| Cage 916 Length CL/cm | 5 ± 0.1 | Covering the |
| | | tapered region |
| | | Cage may be |
| | | D-section or |
| | | along the length |
| Cage gauge | Mesh to be specified | |
| Tail Length, D2/cm | 24 ± 0.5 | |
| Protective Coating/P 914 | Preferable | |
| Seals, S | Ceramic Metal-Vitrilock | |
| | (RTM) | |
| Outer Case | Stainless Steel | |

No doubt many effective variants will occur to the skilled person and it will be understood that the invention is not limited to the described embodiments but encompasses modifications apparent to those skilled in the art found within the spirit and scope of the appended claims.

1-40. (canceled)

41. An oil sensor module for use with attenuated total internal reflection (ATIR) apparatus for optically determining the condition of oil, the sensor module comprising:
an evanescent wave sensor for sensing the oil;
a fluid permeable module housing for said sensor; and
an optical connector for connecting said sensor to said ATIR apparatus.

42. A sensor module as claimed in claim 41 wherein said evanescent wave sensor comprises an optical fibre configured to allow interaction of an evanescent wave of light guided within the fibre with said oil.

43. A sensor module as claimed in claim 42 wherein said fibre includes a tapered portion defining said evanescent wave sensor.

44. A sensor module as claimed in claim 42 wherein said optical connector comprises a portion of said optical fibre of said evanescent wave sensor.

45. A sensor module as claimed in claim 44 further comprising a mirror at a sensor end of said optical fibre.

46. A sensor module as claimed in claim 44 further comprising a mirror at a connector end of said optical fibre.

47. A sensor module as claimed in claim 46 wherein a said mirror comprises a coating on an end of said optical fibre.

48. A sensor module as claimed in claim 41 wherein said determined condition of said oil comprises a degree of degradation of the oil.

49. A sensor module as claimed in claim 48 wherein said module housing comprises a ferrule for each end of said sensor and one or more spacers between said ferrules.

50. A sensor module as claimed in claim 41 wherein said housing is fabricated from ceramic.

51. A sensor module as claimed in claim 41 in the form of a dipstick.

52. Apparatus for optically determining the condition of oil using ATIR, the apparatus including the sensor module of claim 41.

53. Apparatus for optically determining the condition of a fluid, the apparatus comprising:
a light source to provide light for interacting with said fluid;
a detector for detecting a level of light from said light source; and
an optical path between said light source and said detector, said optical path including a reflection from an evanescent wave interface; and
wherein said apparatus is configured such that said fluid may be brought sufficiently close to said interface for an evanescent wave formed by total internal reflection of light at said interface to interact with said fluid;
whereby a condition of said fluid is determinable from said detected light level.

54. Apparatus as claimed in claim 53 for attenuated total internal reflection (TIR) sensing, and wherein said evanescent wave interface comprises a substantially totally internally reflecting (TIR) interface.

55. Apparatus as claimed in claim 53 wherein said optical path further includes at least one mirror between said light source and said detector such that said optical path includes two reflections from said interface.

56. Apparatus as claimed in claim 55 wherein said optical path comprises a fibre optic, and wherein said interface comprises a tapered region of said fibre optic.

57. Apparatus as claimed in claim 55 wherein said fibre optic is provided with a protective housing.

58. Apparatus as claimed in claim 55 comprising a dipstick for sampling said fluid, said dipstick containing said fibre optic.

59. Apparatus as claimed in claim 55 wherein said fluid comprises a lubricant or has an absorbance of greater than unity at a wavelength of said light.

60. Apparatus as claimed in claim 55 wherein said interaction between said evanescent wave and said fluid comprises absorption of light by said fluid.

61. Apparatus as claimed in claim 55 wherein said interaction between said evanescent wave and said fluid includes coupling or propagation of light into said fluid.

62. Apparatus as claimed in claim 55 further comprising a signal processor coupled to said detector and configured to detect a change in said light level to detect a change in the condition of said fluid.

63. Apparatus as claimed in claim 62 wherein said signal processor is configured to detect a degradation in the condition of said fluid.

64. Apparatus as claimed in claim 55 configured to provide and detect light of at least two different wavelengths.

65. Apparatus as claimed in claims 55 configured to determine a degree of light scatter by said fluid.

66. Apparatus as claimed in claim 65 configured to provide and detect light of at least two different wavelengths and to compare detected light levels at said at least two different wavelengths to distinguish a change in detected light level caused by a change in temperature of said fluid from a change in detected light level caused by a change in light scatter of said fluid.

67. A method of optically determining the condition of oil using attenuated internal reflection, the method comprising:
measuring an attenuation of an internal reflection at an interface due to an interaction of light with said oil mediated by an evanescent wave formed at said interface; and
determining a condition of said oil from said attenuation.

68. A method as claimed in claim 67 wherein said oil has an absorbance of greater than unity at a wavelength of said light.

69. A method as claimed in claim 67 further comprising adjusting an extension of said evanescent wave from said interface into said oil to adjust a degree of interaction between said evanescent wave and said oil.

70. A method as claimed in claim 67 wherein said interaction comprises absorption of said light by said oil.

71. A method as claimed in claim 67 wherein said interaction includes coupling or propagation of said light to said oil.

72. A method as claimed in claim 67 comprising measuring said attenuation at two or more wavelengths to determine a degradation of said oil.

73. A method as claimed in claim 72 comprising using said measured attenuation at two or more wavelengths for distinguishing between attenuation caused by a change in temperature from attenuation caused by a change in scatter.

74. A method of determining a degree of degradation of a lubricant, the method comprising measuring a level of particulate scattering by said lubricant; and determining said degree of degradation of the lubricant from said level of particulate scattering.

75. A method as claimed in claim 74 wherein said measuring comprises making a measurement responsive to a complex refractive index value of the lubricant.

76. A method as claimed in claim 74 comprising measuring said level of particulate scatting using two or more wavelengths or colours to distinguish a change in particulate scattering from a temperature change.

77. Optical lubricant sensing apparatus, the apparatus comprising, an illumination source to source illumination at an operating wavelength of the apparatus, and a tapered fibre optic configured to couple light at said operating wavelength out of said taper and into said lubricant, whereby a real of complex refractive index of said lubricant may be determined.

78. An optical sensor module for use with evanescent field sensing apparatus for optically determining the condition of oil, the sensor module comprising:
an evanescent wave sensor;
a module housing for said sensor; and
an optical connector for connecting said sensor to said evanescent field sensing apparatus.
